(19) United States
(12) Patent Application Publication
(10) Pub. No.: US 2004/0133439 A1
(43) Pub. Date: Jul. 8, 2004

(54) Method and system for valuation of complex systems, in particular for corporate rating and valuation

(76) Inventors: Dirk Noetzold, Zollikon (CH); Mark Noetzold, Zollikon (CH)

Correspondence Address: HARNESS, DICKEY & PIERCE, P.L.C., P.O. BOX 8910, RESTON, VA, 20195, US

(21) Appl. No.: 10/644,742

(22) Filed: Aug. 21, 2003

Related U.S. Application Data
(60) Provisional application No. 60/404,745, filed on Aug. 21, 2002.

(51) Int. Cl. G06F 17/60

(52) U.S. Cl. 705/1

(57) ABSTRACT

A system and method are for valuation of complex systems. As a result, a detailed and complete assessment of the current and future state of a complex system can take place. The system and method provide a fully objective, transparent, and accurate way for valuing a complex system because the valuation result is calculated as the integration of detailed valuations of the complex system's constituents. The system and method further provide a complete and consistent treatment of the uncertainties associated with future expectations. The system and method include a structuring method that divides the complex system into representative constituents; a data management system that can collect and store data and results; an expert system that can analyze the data, and; an integration system that can aggregate all appearing quantities including their uncertainties. As optional part it also includes an optimization system and method.

The present application hereby claims priority under 35 U.S.C. §119 on U.S. provisional patent application No. 60/404745 filed Aug. 21, 2002, the entire contents of which are hereby incorporated herein by reference.

### FIELD OF THE INVENTION

The present invention generally relates to rating and valuation systems and methods. More specifically, the present invention relates to at least one of corporate rating, credit rating, and corporate valuation.

### BACKGROUND OF THE INVENTION

Corporate rating or credit rating is currently the closest neighboring field where the presented system and method of valuation has a developed counter part. Other fields where the presented system and method apply do not yet have standardized or quantitative procedures that could constitute a point of reference.

Rating Definition

A credit rating is an opinion of the general creditworthiness of an obligor, or the creditworthiness of an obligor with respect to a particular debt security or other financial obligation, based on relevant risk factors (definition from S&P “Corporate Rating Criteria 2002”). The main elements of the rating processes of the major rating agencies (S&P, Moody's, Fitch Ratings) are very similar and are described in the following.

Current Rating Process

The conventional rating process is based on an analysis that is divided into several categories to ensure that salient qualitative and quantitative issues are considered. For example, with industrial companies the qualitative categories are oriented to business analysis, such as the firm's competitiveness within its industry and the caliber of management; the quantitative categories relate to financial analysis. Thus, proper assessment of credit quality for an industrial company includes not only an examination of various financial measures but also a thorough review of business fundamentals, including industry prospects for growth and vulnerability to technological change, labor unrest, or regulatory actions. In the public finance sector, this involves an evaluation of the basic underlying economic strength of the public entity, as well as the effectiveness of the governing process to address problems. In financial institutions, the reputation of the bank or company may have an impact on the future financial performance. (S&P, page 5)

The rating agency assembles a team of analysts with appropriate expertise to review information pertinent to the rating. A lead analyst is responsible for the conduct of the rating process. Several of the members of the analytical team meet with management of the organization to review, in detail, key factors that have an impact on the rating, including operating and financial plans and management policies. The meeting also helps analysts develop the qualitative assessment of management itself, an important factor in the rating decision. (S&P, page 5)

The rating agency's ratings are not based on the issuer's financial projections or management's view of what the future may hold. Rather, ratings are based on the rating agency's own assessment of the firm's prospects. But management's financial projections are a valuable tool in the rating process, as they indicate management's plans, how management assesses the company's challenges, and how it intends to deal with problems. Projections also depict the company's financial strategy in terms of anticipated reliance on internal cash flow or outside funds, and they help articulate management's financial objectives and policies. (S&P, page 12)

Current Rating Methodology

The rating agency uses a format that divides the analytical task into several categories, providing a framework that ensures all salient issues are considered, e.g. business risk with subcategories industry characteristics, competitive position, marketing, technology, efficiency, regulation, management, and financial risk with subcategories financial characteristics, financial policy, profitability, capital structure, cash flow protection, financial flexibility, etc. (S&P, page 17)

Financial risk is portrayed largely through financial ratios. Examples for relevant financial ratios are: EBIT (Earns before income tax), free operating cash flow/total debt, ROCE (return on capital employed), operating income and sales, long-term debt and capital, total debt/capital, etc. Financial ratios alone can be used to predict default rates and to derive approximate rating results. A default rate is the frequency and the default probability is the probability that a company will fail to service its obligations to the full amount and within the given time. Statistical evaluations of historic default data prove the significance and the relative weight of financial ratios as indicators for default. Financial ratios can be viewed as peer benchmark frame that consolidates the available historic information. Rating results based on financial ratios are often termed rating scores.

Financial risk can also be captured in a more direct approach by modeling the default process and calculating the default probability. A default model, such as the popular and successful Merton model (see the KMV implementation “Modeling Default Risk”, 1993 rev. 2002), describes the evolution of the ratio between assets and liabilities as a stochastic process. The default event occurs when liabilities exceed the assets. The Merton model is essentially a Black-Scholes option model for equity, where the default probability is simply the likelihood that the asset value falls below the default point. Recent extensions consider an uncertain default point (CreditGrades, 2002). This simple model can be very successful, given accurate estimates of asset value and asset volatility. Its main advantages are that it is less dependent on historic data and provides a quantitative model for the future evolution. In context of this model, the market value of the asset and its volatility are viewed as the only relevant aspect of the default information. This also emphasizes the fundamental conceptual difference between the financial ratios method, which focuses on statistically supported benchmarks from historic data, and the default modeling, which focuses on a stochastic description of the future evolution.

Business risk is usually based on a more qualitative analysis. The experts of the rating agency analyze the individual business risk categories and then consolidate the findings into a business risk profile. The business risk analysis provides the complement to the financial ratio analysis. A company with a stronger competitive position, more favorable business prospects, and more predictable cash flows can afford to undertake added financial risk while maintaining the same credit rating.

There are no formulae for combining scores to arrive at a rating conclusion. Ratings currently represent an art as much as a science. A rating is, in the end, an opinion. Indeed, it is critical to understand that the rating process is not limited to the examination of various financial measures. Proper assessment of debt protection levels requires a broader framework, involving a thorough review of business fundamentals, including judgments about the company's competitive position and evaluation of management and its strategies. Clearly, such judgments are highly subjective; indeed, subjectivity is at the heart of every rating. (S&P page 17)

Problems

The existing corporate or credit rating methods have several methodological deficiencies that, in exceptional cases, can lead to severe misjudgments. Other deficiencies concern the precision of the rating result and the efficiency of the rating process. The most import deficiencies are:

First, conventional rating does not provide a detailed and complete assessment of the risks and opportunities. Such an assessment is necessary to obtain a complete picture of the current state and possible future of a firm. Although assessment schemes are structured (e.g. according to industry, region, etc.) and contain special adjustments (e.g. for non-balance sheet obligations etc.), they always leave potentially dangerous loopholes that lead to severe misjudgments. These loopholes are recognized only when the corresponding default event occurs. This has been the case several times in recent history.

Second, conventional rating does not allow a valuation process that can take into account all characteristics and peculiarities of a company. The conventional rating captures the state of the company through a predefined assessment scheme that not necessarily suits the special structure of the company. Rating with financial ratios provides a benchmark compared to the average peer company and therefore does not take into account any peculiarities that are not expressed in the financial ratios. For example, two companies with the same financial ratios will receive the same financial risk rating, even though one of the companies may have most of its risks hedged while the other company is completely exposed. Often the rating contains adjustment procedure for important peculiarities but this process is not sufficiently detailed, standardized, and controlled to guarantee a complete and adequate coverage of all details and peculiarities of a company.

Third, the conventional rating does not allow a fully quantitative valuation that seamlessly includes soft facts into the rating process. The rating process is divided in an evaluation of quantitative (e.g. financial risks) and qualitative (soft facts, e.g. business risks) risk factors. The qualitative rating process requires expert personnel to analyze the corresponding risk factors. The rating process is not based on one coherent methodology that integrates all assessed aspects.

Fourth, the conventional rating process is not fully transparent since the rating of qualitative risk factors requires subjective judgments and by nature is difficult to standardize such that all estimates are based on fully reproducible procedures and results. The rating process is not fully objective.

Fifth, the conventional rating does not allow a consistent treatment of future expectations. Many company data have intrinsic uncertainties, especially estimates about the future evolution of the company. A rating procedure has to provide a consistent framework for the treatment of such uncertainties. The conventional rating methods do not assess the uncertainties in input data, they do not calculate the propagation of uncertainties through the rating process, and they do not quote the rating results with the associated uncertainties or dependence on input uncertainties.

Sixth, the conventional rating does not allow improvements in valuation precision due to the first, second, third, and fifth problems.

Seventh, the conventional rating does not allow a coherent aggregation of all information assessed during the rating process. Qualitative and quantitative aspects are intermixed and are subjectively weighted to derive the overall rating result.

Eighth, the conventional rating does not allow a full comparability of rating results due to second, third, fourth, and fifth problems.

Ninth, the conventional rating does not allow a full interpretation and breakdown of rating results due to first, third, fourth, fifth, and seventh problems.

Tenth, the conventional rating does not allow standardization of the rating process due to the third and seventh problem.

Eleventh, the conventional rating does not allow automation of the rating process due to the third and seventh problems.

### SUMMARY OF THE INVENTION

At least one embodiment of the present invention provides a novel valuation system and method which is designed to obviate at least one of the above-mentioned disadvantages of conventional rating and valuation systems.

An embodiment of the present invention provides a system and/or method of corporate rating or valuation comprising, for example:

(i) selecting a partition of the corporation into non-overlapping units, possibly a partition along one hierarchy level of the corporate;

(ii) entering into a data management system data relating to risks, opportunities, factors and other quantities that represent aspects of said units that are important for the rating or valuation result, including data relating to quantifications of the expectations, uncertainties, and correlations associated with said risks, opportunities, factors, and quantities, possibly through an iterative interactive data collection process that checks data for completeness and consistency;

(iii) analyzing the said data with an expert system, where the expert system possibly compares said units with benchmark units, identifies weaknesses, strengths, risks, opportunities, or factors of said units, and derives suggestions to optimize the operation, performance, or competitiveness of said units;

(iv) aggregating the said risks, opportunities, and quantities including the effects of the said uncertainties and correlations, possibly integrating the equivalent of multidimensional probability distributions;

(v) producing a rating or valuation result, respectively, possibly containing the precision and information about dependencies of the result;

(vi) optionally optimizing the company's operation and/or strategy.

An embodiment of the present invention provides a valuation method and/or system which performs at least one of the following: (1) allows a detailed and complete assessment of the value, risks, opportunities, and other factors that are used to describe the current situation as well as possible future evolutions of a complex system, (2) allows a valuation process that can take into account all characteristics and peculiarities of a complex system, (3) allows a fully quantitative valuation that seamlessly includes soft facts into the valuation process, (4) allows a completely transparent and objective valuation process, (5) allows to treat consistently future expectations with their intrinsic uncertainties, (6) allows a higher valuation precision as compared to conventional methods due to the more detailed and complete assessment, (7) allows the coherent aggregation of all information assessed, including all quantitative and qualitative aspects. (The integration method does exactly this.), (8) allows a fully comparable rating result by a transparent general rating process that generates a rating result together with additional information, e.g. precisions, (9) allows a detailed analysis of the valuation results since this result is based on a detailed assessment and is obtained by a simple mathematical integration, (10) and (11) allows standardization and automation by design.

### BRIEF DESCRIPTION OF THE DRAWINGS

Exemplary embodiments of the invention are described throughout the specification and are illustrated and explained with reference to the figures below, wherein like reference numerals represent like elements and wherein:

FIG. 1 shows a flow chart illustrating a valuation method.

FIG. 2 shows a flow chart illustrating a structuring method.

FIG. 3 shows a standard structuring scheme.

FIG. 4 shows a structuring example.

FIG. 5 shows a flow chart illustrating a data management system.

FIG. 6 shows an illustration of uncertainties associated with historical fluctuations and future expectations.

FIG. 7 shows an illustration of a 2-dimensional normal distribution.

FIG. 8 shows a flow chart illustrating an expert system.

FIG. 9 shows a flow chart illustrating an integration system.

FIG. 10 shows an illustration of the aggregation of uncertainties with correlations.

FIG. 11 shows an example for an aggregation hierarchy.

FIG. 12 shows an illustration of a rating based on the Merton-Model (prior art).

FIG. 13 shows an illustration of a multidimensional valuation with correlations.

FIG. 14 shows an illustration of a rating including correlations.

FIG. 15 shows an illustration of a risk-return portfolio.

FIG. 16 shows a flow chart illustrating the optimization system.

FIG. 17 shows an example for the structuring of company.

FIG. 18 shows an example for the structuring of a production line.

### DETAILED DESCRIPTION OF THE PREFERRED EMBODIMENTS

Overview

A system and/or method of an embodiment of the present application obviates at least one, some or all of the disadvantages of conventional rating approaches. Rating results are calculated from a detailed assessment of the assets and liabilities of the company (or of company projects). The constituent assets and liabilities are valued individually and then are integrated to obtain an overall rating for the company (or for company projects). The default probability (i.e. the probability that a company will fail to service its obligations to the full amount and within the given time) is calculated as the coherent aggregation of all risks and opportunities. That is, the rating is the result of an integration of the possible future fluctuations of the individual assets and liabilities of the company that incorporates the interrelations between the assets, liabilities, and internal and external factors. Fluctuations represent the uncertainties in the future evolution of a company or of a company project. The explicit consideration of fluctuations of company figures and ratios in all steps of the rating process is another aspect of the presented system and method. With this treatment it is possible to assess and control the precision of the rating results. The system realizes a standardization and automation of the rating process with a highly improved performance and precision.

If not otherwise clarified by the context, the following definitions shall apply. “Generalized assets” include assets, liabilities, rights, functions, processes, interfaces (between processes and between functions), interrelations and other objects that can be assigned values or qualities. “Assets” include liabilities where applicable, since the present system treats liabilities as negative-valued assets, and is often used synonymously with generalized asset. “Generalized values” include values or qualities that can be measured and quantified, such as the ordinary value given in units of a currency or such as the different definitions for quality and efficiency. For brevity and readability, “value” is often used synonymously with generalized value. “Valuation” is determination of value. “Rating” is a special case of valuation with the conventional meaning of the corporate rating or credit rating process. “Expectations” are estimates for future values. “Estimates” are conventional estimates or determinations given the available, usually restricted information. “Risks” and “opportunities” are possible positive and negative fluctuations of future values. “Risks” include opportunities where applicable, since the present system treats risks as negative-valued opportunities. “Fluctuations” are changes in generalized values, usually referring to stochastic and frequent changes. “Uncertainties” are possible errors in expectations or estimates. Risks and opportunities are examples for uncertainties. “Factors” are causes, driving forces, influences, or fluctuations that are used as variables or references to describe the dynamics of quantities. “Systematic factors” are factors that can be associated with or can be related to events or movement of specific quantities. They are usually interrelated with other factors. “Unsystematic factors” or “idiosyncratic factors” are factors that are assumed to be purely random and unrelated to other factors. “Average”, “average value”, “standard deviation”, “volatilities”, “covariances” and “correlations” refer to generalized values if appropriate and have their conventional meaning in context of multivariate Brownian processes or time-evolving multivariate normal distributions. They refer to appropriate generalizations in context of more general processes or in an unspecified general context and can implicitly refer to further parameters if appropriate. “Coherent aggregation” and “Aggregation” refer to the integration of individual constituents to an overall unity under explicit and complete consideration of the volatilities of and correlations between the constituents. “Consolidated” means “integrated” and it is left to the context to specify if integration means conventional addition or coherent aggregation.

The following detailed description of at least one embodiment of the system and method relates to the field of corporate rating and valuation. However, embodiments of the described system and method are more general and can be applied to different valuations of complex systems in many areas. In general, the valuation can be an opinion, estimate, assessment, rating or classification of a person, asset, process, project, property, etc. Beyond corporate or credit rating there are many fields where standardized, quantitative and objective valuation methods can present a considerable progress. Examples are the valuation of governments, processes (e.g. organizational processes, production processes), projects, products and services (e.g. research and development, consulting and law, investment services, internet, online, and ASP services), real estate, financial products (e.g. bonds, swaps, convertibles, exotic options), consumer products and services (e.g. household appliances, computer, sports, products and services, food), rent and leasing products and services (e.g. car rental, hotels), vehicles (e.g. cars, ships, planes, trains), methods, projects, strategies, investments, funds, credits, liabilities, securities, insurances, production facilities, supplier, technologies, qualities of products and services (e.g. efficiency, competitiveness, ISO 9001).

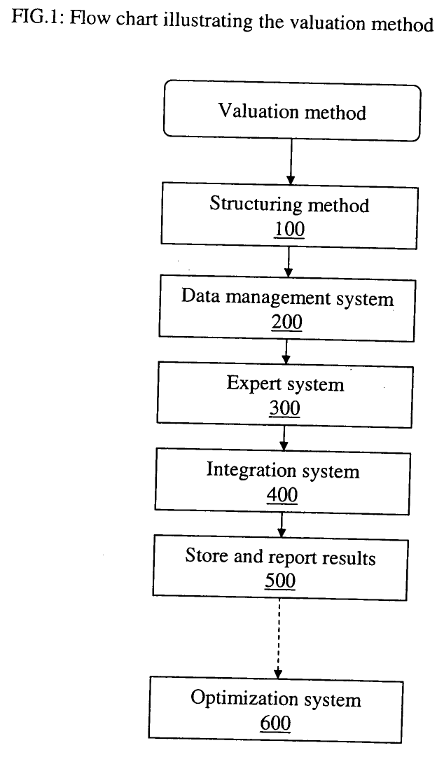

Referring to the companion drawing, FIG. 1 shows the general flow diagram of the valuation method. The valuation method may include, for example, one or more of four or five main parts including, the structuring method (100), the data management system (200), the expert system (300), the integration system (400), and an optional optimization system (500). The structuring method (100) maps the company into a hierarchy of units. The data management system (200) collects and analyzes input data. The expert system (300) performs benchmarking analyses (relative method). The integration system (400) aggregates company figures (absolute method). In a final step all collected data and obtained results are stored and reported. An optional optimization system (500) finds the best solutions for given objectives and constraints.

Depending on the valuation objective, in some cases not all systems components are necessary to achieve the desired results. Then the unnecessary components are considered optional. For example, corporate rating does not require an expert system identifying risks and opportunities from the company's key figures. The system already contains a standard set of major risk and opportunity types that in most cases suffice to achieve rating objectives. In this case the expert system is an optional system that increases rating precision. Of course, optimal results always require all optional systems (also including the specialized extension modules described below).

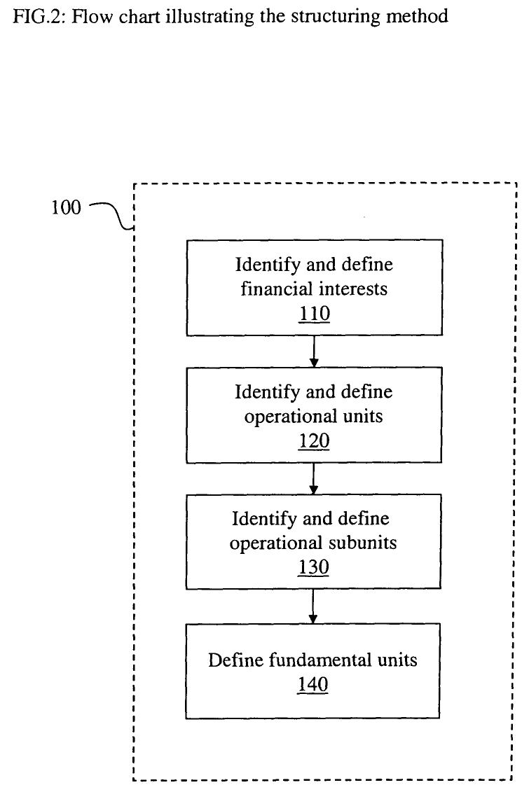

Structuring Method (FIG. 2)

Step 100—Structuring Method:

The structuring method is a main part of the valuation procedure. An objective includes the structuring and partitioning of the company into financial investments and operational units such that a complete and faithful representation of the company emerges.

Step 110—Identify and Define Financial Interests:

In a first step the financial interests of the firm are identified and defined (110). Financial interests are, for example, capital partnerships with or without company character.

Step 120—Identify and Define Operational Units and Step 130—Identify and Define Operational Subunits:

In a next step the operational units (120) and subunits (130) of the firm are identified and defined. If the management of the firm has direct control and responsibility over operational businesses, then this business corresponds to an operational unit, otherwise it is a financial interest.

Step 140—Define Fundamental Units:

The partitioning in operational units and subunits usually corresponds to the hierarchical structure of the company. The structuring and partitioning depends on the breadth and depth of diversification in the company. At the lowest hierarchy level the units are associated with products or functions, depending on the organizational structure of the company. These units at this level are called fundamental units (140). At this level data are available through management information systems or controlling systems.

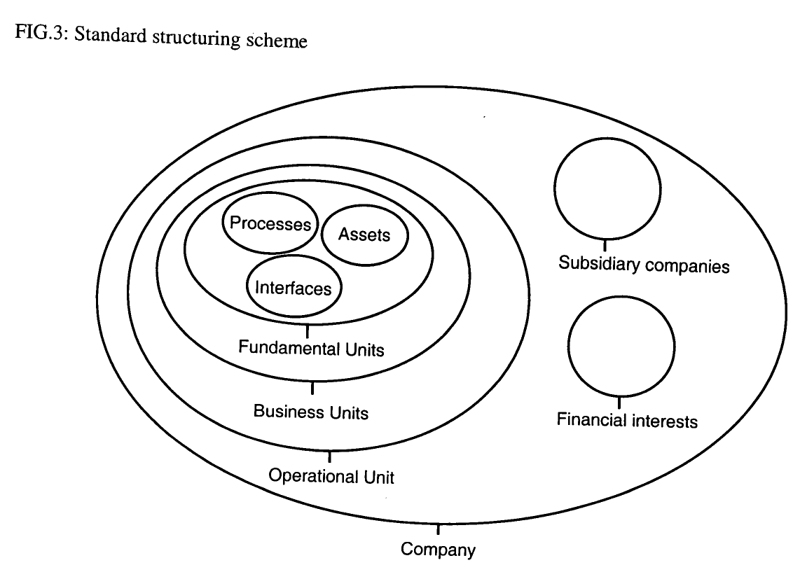

It is an important aspect of the structuring method that it guarantees a complete and consistent partitioning of the company into non-overlapping units while conserving characteristics and interdependencies. The standard structuring scheme is shown in FIG. 3. A company structures into operational units, financial interests, and subsidiary companies. The subsidiary companies are also structured according to the standard structuring scheme.

The operational units usually include business units. The business units are associated with the products of the company and usually are organized as profit centers. The business units contain fundamental units that are associated with functions or products. Some companies are structured directly into fundamental units, with no business units at all or with business units only at a lower hierarchy level (functional organization). To cover all cases, the fundamental units are defined to be the lowest level of units including either business or functional units. The fundamental units include generalized assets (as defined above). The individual elements discussed here (and represented by ovals in FIG. 3) need not exist, exist only once, or exist several or many times.

The basic elements of the valuation analysis are the generalized assets. For consistent and complete assessment of all constituents of the company it is important that not only assets and liabilities are considered and quantified. The present valuation system also considers processes and interfaces between processes and functions as main elements of the identification and quantification procedure, on the same level and of same importance as assets and liabilities.

For the vast majority of companies the standard structuring scheme provides the basis for a faithful mapping of the company structure. In special cases when the standard structuring scheme does not properly cover the structure of a company, extensions or reformulations of the standard structuring scheme are used. Reformulations take the elements of the standard scheme (represented by ovals in FIG. 3) but combine them differently. For example, in an extension of the standard scheme, operational units or business units contain further subsidiary companies and financial units.

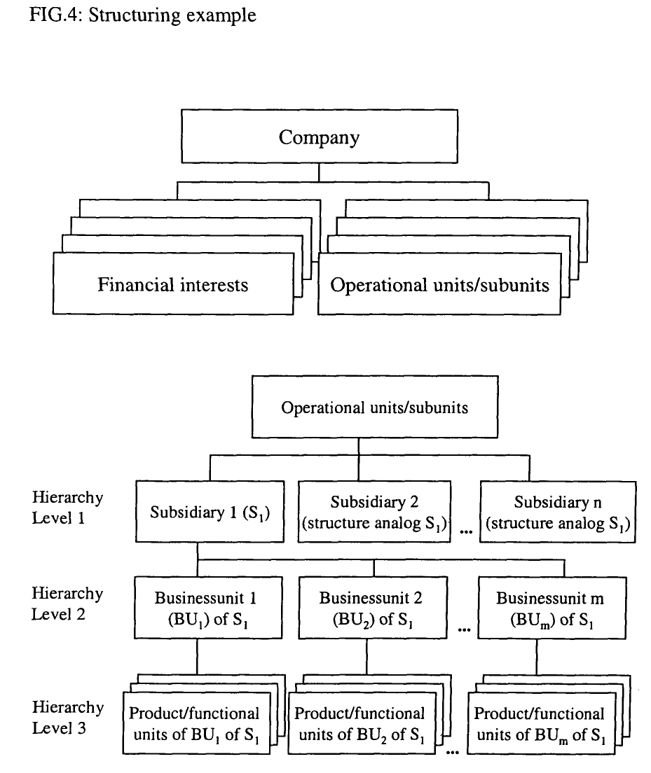

A specific example for the structuring method is shown in FIG. 4. The company has of two types of units: financial and operational units. In this example the first hierarchy level includes several subsidiary companies, the second hierarchy level includes business units and the third hierarchy level includes fundamental units, i.e. product or functional units. In another common case without subsidiary companies, the first hierarchy level would be the level of business units.

The structuring and partitioning lays the basis for one or more advantages of the present valuation method compared to conventional methods, including for example: (1.) The present valuation does not rely on consolidated data. It achieves precision and transparency due to details available at the lowest hierarchy level. (2.) It identifies and incorporates additional and company specific information contained in correlations and interdependencies of the subunits. (3.) The present method and system allows a consistent breakdown of the results into details and origins, from the lowest to the highest hierarchy level. This facilitates enormously company specific analyses, valuations, interpretations and optimizations.

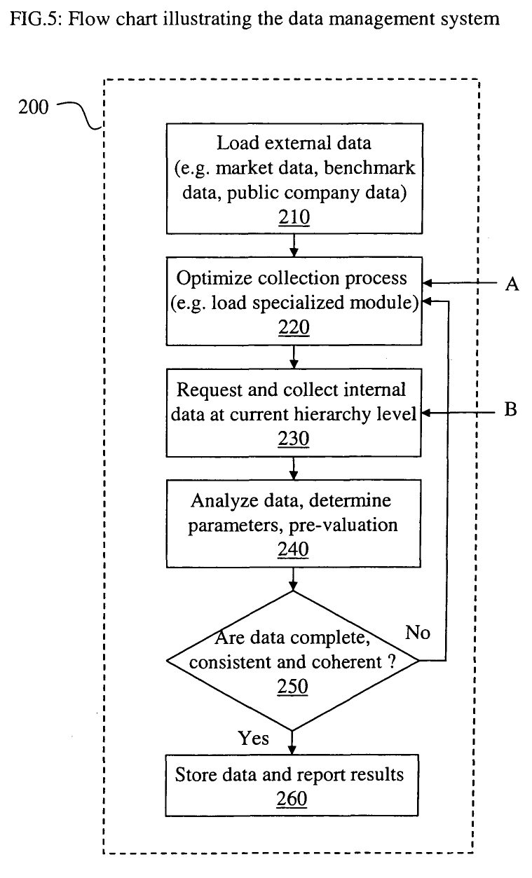

Data Management System (FIG. 5)

Step 200—Data Management System:

The data management system (200) is another main part of the valuation procedure. It includes a basic unit and a controlling unit. The basic elements are steps (210), (230), and (260). They request, load and store necessary data and thus constitute a functioning data management system. The steps (220), (240), and (250) are the intelligent extension that optimizes the data collection process. The optimization guarantees that only those data will be requested that most probably will lead to the largest improvement in valuation precision. The system contains two entries from other systems. (The entries apply only if the requesting systems exist.) Entry (A) is a data collection request from the integration system and entry (B) is a data collection request from the expert system.

Step 210—Load External Data (e.g. Market Data, Benchmark Data, Public Data):

The data management system starts by collecting external data as a basis of information (210). This data basis usually consists of market data, benchmark data, and public company information, such as balance sheet or profit-and-loss statements (210). Those data are obtained from public and commercial data bases (SEC data, company publications, industry sector data, market surveys, analyst reports, company information provider, financial market data, economic and political data, business associations, hazard event data, etc.) The data include external factors and their correlations. The external factors refer to events outside of the company. Typical external factors are financial indices, e.g. interest rates or exchange rates, economic indices, political events, e.g. strike, or hazards, e.g. fire, weather. The system contains a standard set of factors, mostly representing financial, industry and economic data. The current system contains optional modules for specific industry sectors and business functions with data that can be updated over a network, e.g. over the internet.

Step 220—Optimize Collection Process (e.g. Load Specialized Module):

From this basis of data the data management system derives specific settings that are used to govern the further data collection process (220). Based on external data the system roughly estimates which financial unit, operational unit or other unit is expected to have the largest impact on the valuation result, e.g., in the case of rating, the largest losses and gains. The system optimizes the data collection procedure (1.) by requesting only data that are necessary to achieve a given precision in the valuation process, and (2.) by concentrating on factors that usually govern the dynamics in the given sector of industry, and (3) by ranking sets of data according to their importance for the valuation result. The specific settings usually correspond to one or more pre-configured modules that contain sets of rules based on expert knowledge and that provide a good model for the considered company, business unit, or fundamental unit. The model provides a first approximation for the set of required data and for the ranking of data. In case of entry from step 250 (incomplete, inconsistent or incoherent data) or from A (from step 440, precision does not fulfill requirements) the system requests more input data.

Step 230—Receive and Collect Internal Data at Current Hierarchy Level:

The actual data collection (230) is a real-time interactive process since it provides feedback to the user or to the external system that delivers the data. For example, the user or the external system can decide, based on the information that is generated during steps (220)-(250), if the gains in precision do justify further data acquisition. If no internal data are available or the available internal data are already collected, i.e. the request for internal data is denied, step (230) terminates and the system continues with a final valuation. A valuation based solely on external data is possible but not as precise as with full data support.

The collected data (230) usually include internal confidential company data. Those data are received electronically from company databases or are entered manually into the user interface of the system. The data originate from controlling, accounting, product units, function units, and from personal interviews with business unit managers, clients and suppliers. The system requests risks and opportunities, internal factors and their correlations, all at the current hierarchy level (see FIG. 4). Typical internal factors are measures of product quality, satisfaction of personnel, or hazards, e.g. computer or database failure. In case of entry from B (from step 350, additional data are necessary for quantification) the system requests more input data.

Some features compared to existing valuation processes can include: (1.) The data collection and analysis proceed on microscopic levels, usually progressing from higher hierarchy levels to lower levels corresponding to the fundamental units. For high-precision objectives, the data collection and analysis starts immediately at the level of fundamental units. The valuation result is the integral of those microscopic valuations. The microscopic data at the fundamental hierarchy level usually are confidential company data. Those data include, among others, cost and profitability data as well as soft facts. Existing data collection and analysis procedures do not include such data, especially not in systematic or company-wide manner. (2.) The data collection and analysis processes cover all units in a homogeneous and coherent manner. There is no picking of certain units according to a-priori importance. The importance of specific units is only known a-posteriori, as part of the result that incorporates all other units as well as the complete correlation information. For the same reason the intelligent components of the data management system use pre-valuation to estimate the relative importance or impact of input contributions. There is also no picking of certain figures or factors representing the financial or competitive situation of the company. Again, the importance of those figures and factors is a result of the described data collection and analysis method. (3.) The data collection and analysis consider correlation information. Existing methods and systems do not include this information, especially not with the necessary rigor and mathematical exactness. (4.) The data collection and analysis process carry the full probability information, i.e. information about fluctuations and uncertainties. Existing systems and methods do not consider this information. For valuations that are based on predictions or future events it is necessary to consider deviations from average expectations since uncertainties usually are an intrinsic feature of predictions. (5.) The data collection also includes the uncertainties of estimates. Especially for sparse data the estimates may not be precise and the corresponding uncertainties can have an impact on the results.

In the special case of corporate rating and manual data collection over the user interface of the system, the estimates are a result of a joint effort by the Risk Owners and the Risk Profilers. The Risk Owner is the person responsible for the asset to be valued. The Risk Profiler is the person responsible for the valuation process. Risk Owner and Risk Profiler represent two complementary aspects of the data collection process. The Risk Owner knows the properties and peculiarities of an asset and identifies, qualifies and quantifies the risks, chances and dependencies. The Risk Profiler supports the Risk Owner through the quantification process and transfers and classifies this information within the framework of the valuation process (e.g. based on a risk catalog or risk database). The collaboration of Risk Owners and Risk Profilers guarantees a unique company-wide standard for data collection, a higher level of precision, and a much more efficient collection process. It is possible, of course, that a single user assumes the role of both, Risk Owner and Risk Profiler.

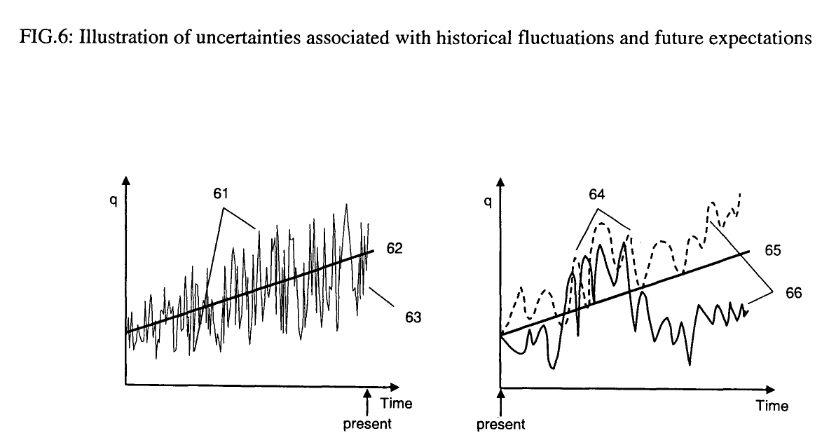

The collected data include estimates of uncertainties associated with fluctuating quantities or future expectations. FIG. 6 shows examples for the two types of uncertainties. Historical fluctuations (61) with their average movement over time (62) and possible future realizations (64) around the average expected movement (65). For example, the first type of curve is the past evolution of an exchange rate with its average trend over a short period and the second curve are two expected future evolutions of the same exchange rate. In the first case the curve fluctuates around its average (63) while in the second case the individual realizations can divert strongly from average expectations (66). The size of the fluctuations around the average in the first case and the size of uncertainty in the future expectations in the second case are determinants of the underlying dynamics of the curves. The sizes of these uncertainties have to be captured for any sensible description of fluctuating quantities or future expectations. It is a feature of at least one embodiment of this invention that these uncertainties and their correlations are requested and integrated. Conventional valuation methods and systems often focus exclusively on average values.

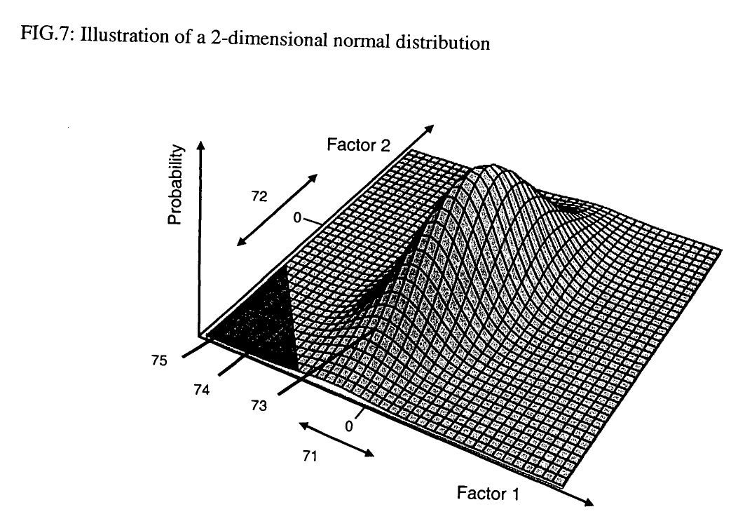

A common description for quantities with uncertainties is in terms of probability distributions or stochastic processes (e.g. multivariate normal distributions, as described below). The distributions or processes are further specified by parameters, e.g. the average rate, the volatilities, the correlations, etc. FIG. 7 shows an example of a 2-dimensional normal distribution of factors with volatilities σ₁=0.1 (71) and σ₂=0.2 (72) and correlation ρ=0.5. The positive correlation implies that fluctuations with both factors moving in the same direction are more likely (73). Linear combinations of factors correspond to straight lines (74) and the volume below the shown surface (75) gives the probability that the linear combination of factors falls below a given value. Another, more mechanical and implicit description of the spectrum of fluctuations is in terms of genetic algorithms or neural networks.

In most cases it is not a sensible method to determine and collect all interrelations (e.g. volatilities and correlations) between all fluctuating quantities. For practicability and performance the system approximates fluctuations by functions of linear combinations of factors. The advantage of such a method is that very large numbers of correlations between quantities can be captured by a much smaller set of factor correlations while maintaining roughly the same level of precision. For example, a set of 100 quantities will require approximately 100×100/2=5000 correlations between them. Usually, a set of 100 quantities can be reliably approximated with about 10 factors at roughly the same precision. These 10 factors require only 45 correlations. A further advantage is that correlations between factors are generally much easier to measure.

Fluctuations that can not be described by the set of factors are captured by an idiosyncratic factor. The system automatically distinguishes an exact calculation from an approximate factor calculation by checking the existence of an idiosyncratic factor. The mode of calculation is thus controllable by data input. Generally, the differences between these two modes of valuation are small in terms of precision of the final results, but large in terms of performance.

The set of factors and their correlations are basic inputs collected by the data management system. The parameters describing a factor probability distribution can be extracted from historic data series or from current market data or can be guessed. For example, assuming that exchange rates can be described by a multivariate normal distribution, one can estimate their volatilities and correlations from historic exchange rate data. The estimate itself contains several parameters, such as the length of the sample period or the weight function that emphasizes new data. The total error of the estimation process contains the errors from the assumption of a multivariate normal distribution and the errors from arbitrary sample periods or weight functions. Uncertainties in estimating the factors are also important input data. For rare data the estimation uncertainties can become as large as the underlying estimate. These effects are therefore treated with the same methods and at the same level as all other uncertainties. Similar estimation errors appear in the example of a genetic algorithm or neural network that is trained on a historic data set. It is preferable that these estimation uncertainties are fully captured.

The factors provide a basis for the description of other quantities. As described above, the dynamics of the quantities contain uncertainties associated with fluctuations or with future expectations. The uncertainties are modeled by functions that depend on a linear combination of factors. Such a linear combination is specified by a set of weights, henceforth called factor weights. For example, the quantity under consideration is the turnover of a company's subsidiary in a different currency zone. The fluctuations of the turnover measured in the company's accounting currency depend strongly on the exchange rate between the two currency zones. The turnover is a linear function of the linear combination of factors with a relatively high weight for the exchange rate factor. The factor weights also determine the volatility of the turnover.

Step 240—Analyze Data, Determine Parameters, Pre-Valuation:

The data are analyzed for consistency, coherence, and completeness (240). That includes, of course, verification that all quantities necessary for the valuation process are given. Completeness also implies that those data suffice to achieve a desired valuation precision. A preliminary valuation (pre-valuation) is often necessary to assess the valuation precision that can be achieved with a given set of data. This pre-valuation is an integration based on the currently existing data set. The pre-valuation includes the integration of all individual units on all hierarchy levels. The collected data are also examined for consistency, e.g. by verifying the validity of constraining relations among sets of data, and for coherence, e.g. by verifying that the collected data were generated by methods of comparable precision. In case of a description by a set of factors (see Step 230 above), a result of the current analysis is a new set of orthogonalized and normalized factors that correspond to the eigenvectors of the correlation matrix. This new set of factors is a linear transformation of the original set of factors. The new set of factors has the advantage that orthogonality and normalization yield an invariant definition of size and also greatly simplify many operations. This set is utilized internally to define an invariant measure of precision and to boost performance.

Step 250—Are Data Complete, Consistent and Coherent?:

The data collection is an iterative process (250). If the data are either not consistent or not sufficient to achieve the required valuation precision, further data collection steps are necessary (250). The optimizing step (220) guarantees that only those data will be requested that most probably will lead to the largest improvement in valuation precision. Data that were neglected at this step can still be collected in a later step, if they turn out to be important (250). Of course, if the iterative or interactive features of data collection procedure are turned off, data collection proceeds in one step. In this case, the valuation process will halt if the check for data consistency or data completeness fails (250). The system provides real-time monitoring of overall results and overall precision and it indicates the impact of current inputs.

A specific example for the criteria in the data verification process (250) is the following. Many important figures in corporate rating or corporate valuation depend on future expectations. The uncertainties in those future expectations require quantification. The scale of the uncertainties is often parameterized in form of volatilities or covariances. The covariances for N factors are represented by a symmetric N×N matrix with N(N+1)/2 different elements. Quantities like covariances can be estimated from historic series (experience) or can be given as pure estimates (expectation). Data completeness requires here, among others, that a complete set of those N(N+1)/2 quantities specifying the uncertainties is given. Data consistency requires here, among others, that the calculated or estimated co-variances satisfy all the constraining relations that one could expect from the mathematical formalism. Data coherence requires here, among others, that the calculations or estimates leading to the covariance data were done with comparable precision to guarantee homogeneous data quality.

Step 260—Store Data and Report Results:

The complete set of data and intermediate results (e.g. valuation parameters) are stored for later use (260). An optional report (260) summarizes the main characteristics of the collected data, the data analysis, the intermediate results, and the pre-valuation results. The report also shows all other status information, such as name and origin of the data used (e.g. file names, data bases used) and other information that was generated during operation of the data management system, such as error and warning messages, user requests, interactions with other systems, etc. The report essentially contains all the information that is necessary to reconstruct the details of inputs (i.e. provides complete history).

The data management system contains several features that have not been used previously in this or a similar setting for corporate rating or valuation. It includes at least one of the following features: (1.) selective data collection optimized for highest valuation precision at minimum data requirements, (2.) complete control over valuation precision, since all procedure steps carry precision figures, from data input to result output, (3.) superior valuation precision due to microscopic analysis that integrates information from the lowest hierarchy level into a precise global result, (4.) superior valuation precision due to the explicit consideration of risk and opportunities, (5.) superior valuation precision due to explicit consideration and quantification of so called soft facts, such as reputation, management quality, etc.

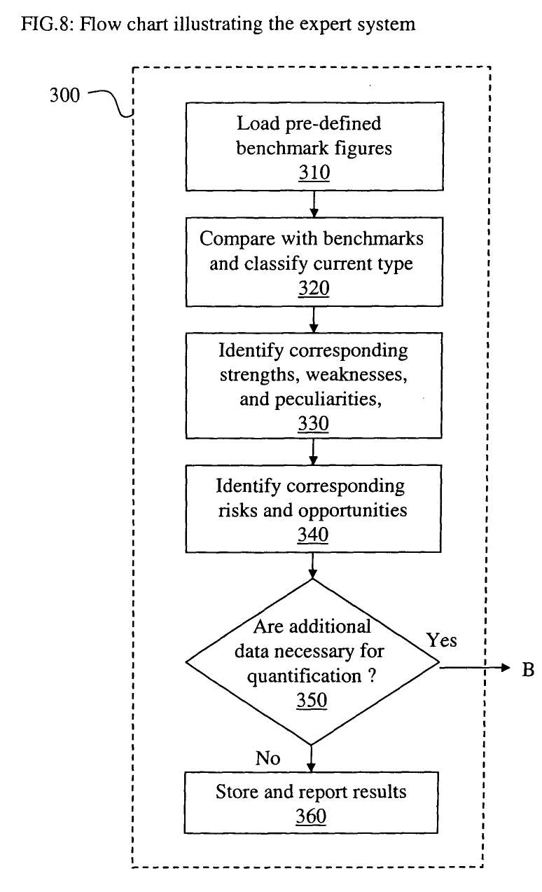

Expert System (FIG. 8)

Step 300—Expert System:

The expert system (300) is another main part of the valuation procedure. Its task is the analysis of the given company data. The analysis is based on a sophisticated benchmarking method. The expert system emits requests (B) to collect additional data. (The request applies only if a data management system exists.)

Step 310—Load Pre-Defined Benchmark Figures:

Initially the expert method loads the different benchmark figures that act as reference models for different kinds of companies or different combinations of company data (310). The benchmark data have been collected by the data management system from market data, industry data, public company data, etc. (210). For example, the benchmark data for an industry sector consist of values or ranges of values for the main factors, correlations, corporate or financial figures and ratios that are characteristic for that branch of industry. These benchmark data are created by statistical analysis of historical datasets or are derived from given sets of rules or constraints hat characterize certain types of companies.

The benchmarking procedure always compares a given company unit with a reference unit within the same company (internal benchmarking) or with a reference unit outside of the company (external benchmarking). (1.) The external benchmarking compares with the generic, external market or industry figures. The purpose of the external benchmarking is to value relative to the market average, industry, or competitors. Those reference data were collected in step (210). At a lowest level of analysis, a given fundamental unit is compared with a similar generic fundamental unit that represents market or industry standards or competitors. Quite often no such reference units exist because at this level of analysis only few comparable competitors exist and no data are available. In those cases the external benchmarking does not generate any additional input. (2.) The internal benchmarking compares units that lie within the same company and have the same parent. The purpose of the internal benchmarking is to quantify the relative importance of sister units, transforming absolute performance figures into a percentage of overall operational performance. The reference figures for internal benchmarking contain the common and average features of sister units. Both, the external and the internal benchmarking method identify the similarities and differences compared to an average or normal operation.

Step 320—Compare With Benchmarks and Classify Current Type:

The expert system starts the analysis by comparing the company or unit figures with those of the benchmark companies or benchmark units (320). That locates the given company or unit within the set of benchmark companies or units and provides a first classification. This classification expresses the characteristic features of the given company or unit in terms of the benchmark companies or units.

Step 330—Identify Corresponding Strengths, Weaknesses and Peculiarities:

In a next step the expert system identifies the peculiarities of the given company or unit (330). Peculiarities are the characteristics of the company or unit that are not covered by the benchmark figures. They provide first conclusions and valuable hints for further examinations. The extraction of peculiarities is an important step in (1.) identifying weaknesses and strengths relative to competitors, (2.) deriving aims to improve competitiveness, (3.) identifying the individual risks and opportunities of the fundamental units. The benchmarking process employs mathematical formulas that test for deviations from average behavior and for the significance of those deviations.

Step 340—Identify Corresponding Risks and Opportunities:

In a next step the expert system identifies the risks and opportunities of the given company or unit (340). The general frame of risks and opportunities is determined by the classification with respect to the benchmark companies or units. For example, the common risks and opportunities of the industry sector are already contained in external benchmark figures. The specific risks and opportunities and possible strategic consequences are derived from the peculiarities that were extracted in step 330.

Step 350—Are Additional Data Necessary For Quantification?:

If peculiarities are identified and additional data and analysis are required for quantification, further data collection steps are necessary and a request (B) is sent to the data management system (230). The hierarchy level has to be adjusted for step 230.

Step 360—Store and Report Results:

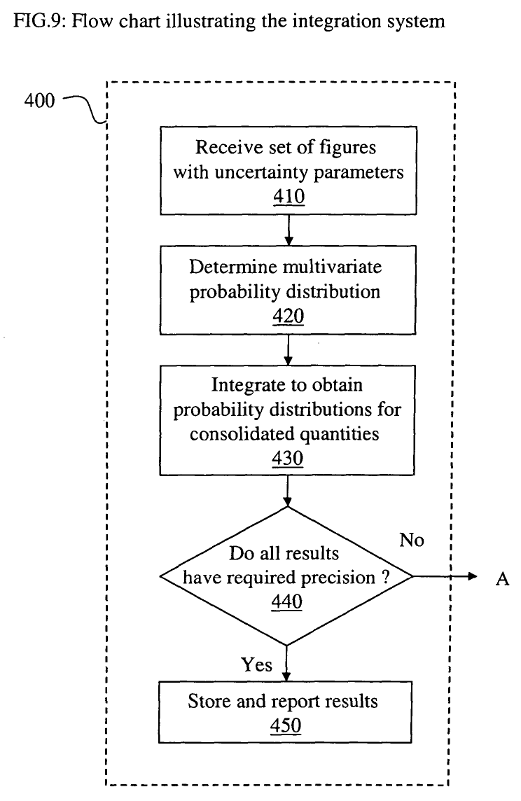

In a final step (360) the expert system stores the calculated results in the data management system and also creates a report. The report shows status information and other information that was generated during operation of the expert system, such as error and warning messages, user requests, interactions with other systems, etc. Integration system (FIG. 9)

Step 400—Integration System:

The integration system (400) is another main part of the valuation procedure. Its task is the consolidation of company data by coherent aggregation. Coherent aggregation (also called aggregation for short) is an integration that takes full account of the correlations (more generally, interrelations) between the quantities to be integrated. The importance of this method derives from the fact that not all quantities, especially not fluctuations, can be added like numbers. Uncertainties in estimates or uncertainties in future expectations require more complex mathematical models for consistent integration. A correct coherent aggregation method is e.g. a mathematical integration or simulation with multivariate probability distributions. The integration system emits requests (A) to collect additional data. (The request applies only if a data management system exists.)

Step 410—Receive Set of Figures With Uncertainty Parameters:

The first step of the integration system is data acquisition (410). The data include quantities that quantify a state, such as e.g. the figures from balance and profit-loss statements, and quantities that quantify uncertainties or future expectations, such as e.g. risks and opportunities in the figures from balance and profit-loss statements. The new feature of the valuation described here is that it considers the uncertainties of all quantities and carries their influence through the whole valuation process. The uncertainties in fluctuations or future expectations are often modeled with stochastic processes or multivariate distributions and are parameterized with volatilities, correlations and other measures. The integration system expects the received data to supply the necessary probabilistic information.

Step 420—Determine Multivariate Probability Distribution:

In the next step of the integration system a consistent and coherent model of the supplied data has to be given that represents the data in a form suitable for integration (420). Data sets at this stage in the valuation process always are in form of probability distributions, specified at least by the quantity's average and fluctuation (i.e. in form of standard deviation, variance, or volatility). For example, predictions, estimates, or expectations of future turnover should only be quoted with its standard deviation, say, with 10% uncertainty over one year. Also, the factors for those uncertainties need also be specified and quantified. In the case of turnover, such factors could be general economic development, exchange rates for export or import oriented companies, local weather for electricity provider, etc. Many mathematical models exist to combine the effects of fluctuations and correlations into a consistent description. Those models differ in aspects that emphasize mathematical representation, characteristics, precision, etc., but are based on similar aggregation logic and lead to similar aggregation results. A popular model is the multivariate normal distribution (or process; with or without copulas). It can describe the dynamics of many quantities including their fluctuations. The model is specified by parameters, such as averages, volatilities, and correlations of the quantities. Those parameters have to be calculated for all quantities in the data set, if the multivariate normal distribution is adopted as data model.

For example, often a quantity q under consideration is modeled as term depending on a linear combination of several factors f=(f₁, . . . ,f_{N}) and on an idiosyncratic factor ε with weights w₁, . . . ,w_{N},w_{ε}:

q=b(w₁f₁+w₂f₂+w₃f₃+. . . +w_{N}f_{N}+w_{ε}ε)

where b is an empirically or analytically derived function. In the simple case that the factors f₁, . . . ,f_{N} and ε obey a Brownian motion, their associated probability distribution is an evolving multivariate normal distribution:

φ(f,ε)=φ(f)φ(ε)

φ(ε)=(2πσ_{ε}²t)^{-1/2} exp [−ε¹68 /(2πσ_{ε}²t)]

φ(f₁,f₂, . . . ,f_{N})=(2π)^{-n/2(}detΣ)^{-1/2} exp [−(f¹Σ⁻¹f)/2]

f=(f₁,f₂, . . . ,f_{N})

$$\sum = ( \begin{matrix}{σ}_{11} & ⋯ & {σ}_{1 N} \\ ⋮ & ⋱ & ⋮ \\ {σ}_{N1} & ⋯ & {σ}_{NN}\end{matrix} ) t$$

where σ_{ε} is the volatility of the idiosyncratic factor, Σ is the covariance matrix of the factors f₁, . . . ,f_{N}, N is the number of factors, σᵢ=σᵢσₖρᵢₖ denotes the covariance between factors i and k (with i, k=1, . . . ,N ), σᵢ is the volatility of factor i, ρᵢₖ is the correlation between factors i and k, and t is the time elapsed. FIG. 7 shows the form of a 2-dimensional factor probability distribution with correlation. Internally the systems employs orthogonalized (no correlations) and normalized (unit volatility) factors to improve performance. These orthonormalized factors are obtained by a linear factor transformation.

Step 430—Integrate to Obtain Probability Distributions For Consolidated Quantities:

As before, the dynamics and uncertainties of unconsolidated quantities are represented by a probability distribution. The corresponding consolidated data are obtained by mathematical integration of the (multivariate) probability distribution (430). For example, assuming that the multivariate probability distribution contains the turnover probability distributions of several business units, the total consolidated turnover of all business units is then given by the probability distribution that results by integrating over the all individual turnovers with the constraint that the total turnover is the sum of the individual turnovers. The result for the total turnover is again a probability distribution and its average is the expected turnover. The fluctuations of all individual turnovers aggregate to the overall uncertainty in the consolidated turnover.

The aggregation of quantities with uncertainties is not based on their uncertainties alone. The correlations are also a main ingredient because they determine how the uncertainties are combined. The correct treatment of correlations usually requires extreme care and can only be accomplished with sophisticated tools or complex mathematical formulae. For example, the turnover of several business units is usually consolidated into the total turnover by adding the individual turnover contributions. This procedure is only correct if no uncertainties or fluctuations are considered. The future turnover of the company or of business units usually are based on estimates or projections that have uncertainties associated with them. If the individual business units depend on different combinations of factors, as is almost always the case, then the fluctuations in the individual turnovers do not simply add, but integrate due to a more complex method, as described above. Generally the overall uncertainty decreases as many individual fluctuations cancel or diminish each other during aggregation. Only in the very special case where all business units follow the same factor combination the correlations are maximal and the turnover fluctuations would add up. The cancellation of individual fluctuations is quite similar to the well-known diversification effects in portfolio theory.

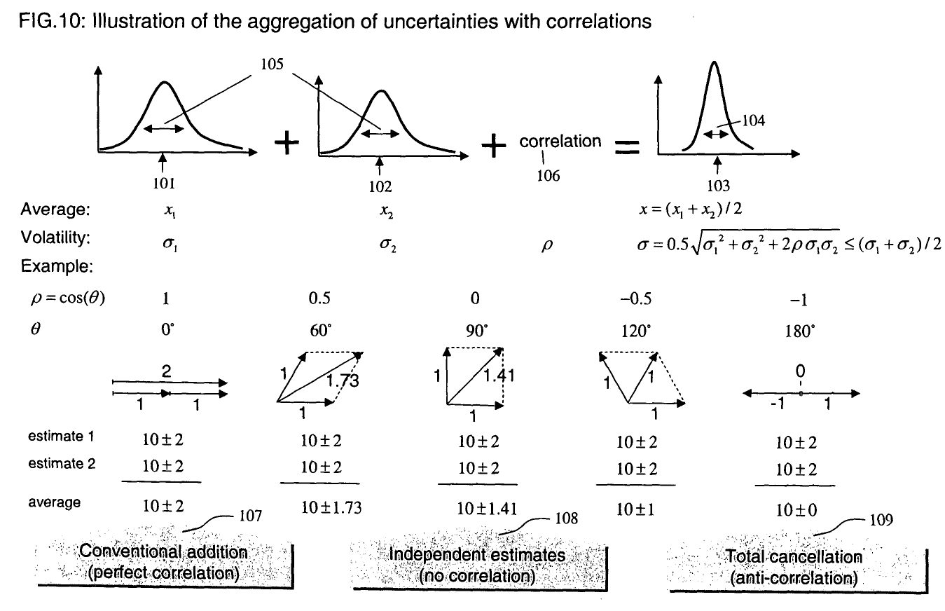

The diversification for different correlations is depicted in FIG. 10 for the aggregation of two distributions, each with average value 10.0 (101), (102) and standard deviation 2.0 (105), e.g. resulting from two expectations for future stock values. Naïvely it is expected that the resulting prediction is 10.0 with standard deviation 2.0, since both estimates agree in value. However, that result is true only for the case that both expectations are based on exactly the same reasoning, i.e. factors (107). The correct result has the same average expected value (103), value 10.0 as before, but with different standard deviations (104), varying between 0.0 and 2.0. That is, the general case with different underlying factors, i.e. non-perfect correlation (106), leads to diversification. FIG. 10 depicts cases of small or no correlation (108), anti-correlation (109), and intermediate correlations. With some simplification, the coherent aggregation of uncertainties can be visualized as vector addition, where the correlation corresponds to the angle between the vectors to be added and very similar to Pythagoras formula which describes the addition of side lengths of a triangle, see FIG. 10. With the notations from above the square of the volatility of an aggregated quantity (103) is given by:

$${σ}_{consolidated}^{2} = {\sum }_{i}^{} {\sum }_{k}^{} {w}_{i} {w}_{k} {σ}_{ik} = {\sum }_{i}^{} {\sum }_{k}^{} {w}_{i} {w}_{k} {σ}_{i} {σ}_{k} {ρ}_{ik}$$

Even though the previous example oversimplifies the actual diversification because fluctuations of quantities are generally non-linear functions of the factors, the cancellation effects nevertheless remain large. The aggregation with cancellation of individual fluctuations is the basis for the improvement with respect to existing valuation systems and methods.

Another consequence of the diversification is that subjective estimates in the input data are averaged while objective or common estimates survive the aggregation. This is due to the fact that subjective estimates contain a much larger part of idiosyncratic fluctuations. Thus, in the case of lack of data, when subjective estimates of experts are an essential input for a valuation, the presented system and method will result in a much more objective result than what is naively expected. A further improvement is of course that the uncertainty in the estimates is independently captured; see the example after (230).

The integration system is conceptually and mathematically equivalent to the simulation of possible future evolutions of the company. It is the sum over all the future states where each state corresponds to a specific combination of realized factor values. The outcome of many simulations is a spectrum of different valuation results. This spectrum of valuation results is characterized by the average value and a standard deviation as scale of uncertainty around the average value. The described integration system is based on a consistent evolution model for uncertainties with factor weights and correlations.

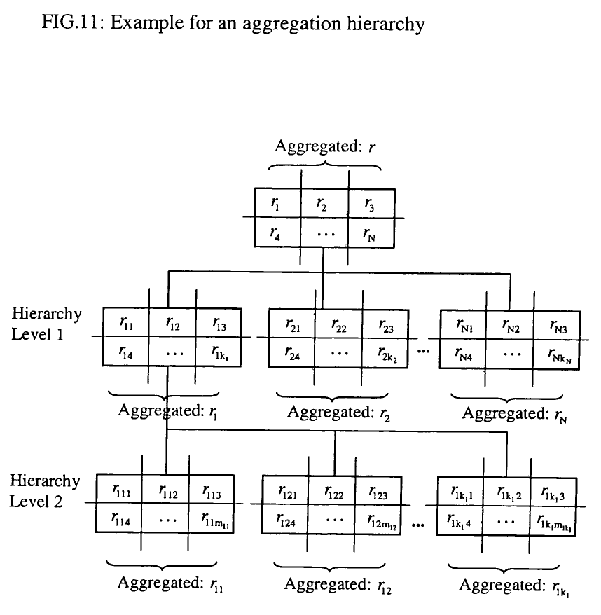

Aggregation can proceed in several steps, e.g. from a lower hierarchy levels to higher levels. This is illustrated in FIG. 11, where the risks and opportunities of an operational unit are aggregated over two hierarchy levels and where the structuring follows the example of FIG. 4. The integration system uses two methods for the aggregation of aggregated quantities. The standard method is to aggregate in a factor representation. A fallback method is to go back to the lowest hierarchy level and aggregate with known correlations.

Step 440—Do All Results Have Required Precision?:

If the results do not have the required precision, further data collection steps are necessary and a request (A) is sent to the data management system. The optimization step (220) guarantees that only those data will be requested that most probably will lead to the largest improvement in valuation precision. This optimisation step can be an iterative process with a maximum of two loops before the system automatically stores and reports (for example, in case that a requested precision of 0.001% cannot be reached, even for an abundant supply of data). The system shows a message that the required precision cannot be achieved.

Step 450—Store and Report Results:

In a final step (450) the integration system stores the calculated results in the data management system. It also creates a report with system messages, such as error and warning messages, user requests, interactions with other systems, etc.

Some features of the described integration system as part of a valuation process include: (1.) Quantities are aggregated together with their intrinsic uncertainties. The difference to conventional balance or profit-loss calculations is that there is a second dimension to all quantities that quantifies the uncertainties, i.e. the deviations from expectations. (2.) This additional second dimension of uncertainties involves the method of coherent aggregation that generalizes the conventional addition. Uncertainties do not add like ordinary numbers but more like vectors, see FIG. 10. (3.) Since uncertainties usually arise from a variety of different origins, diversification appears as an effect of aggregation. Generally, aggregated overall uncertainties are not as large as the sum of the individual uncertainties.

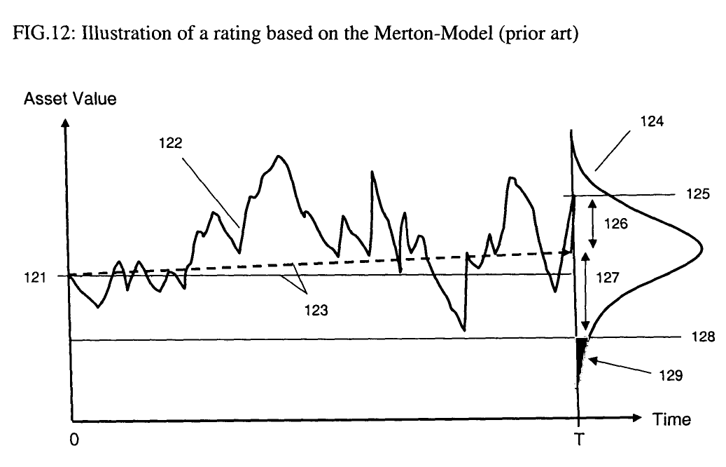

Coherent aggregation is a new aspect of at least one embodiment, compared to conventional valuation schemes. FIGS. 12 to 14 illustrate at least some of the differences between new and conventional valuation for the case of corporate rating. The Merton Model in FIG. 12 is the basis of most successful conventional rating schemes. It considers the evolution (122) of the asset value of the company from an initial value (121) with average growth rate (123) into the future. The probability distribution (124) of future asset values is characterized by the volatility, i.e. the size of fluctuations (126) which is given by the difference between realized values (125) and the average expected value. The so-called Distance-to-Default (127) gives the value difference to the default point (128). At default value the asset value falls below the liabilities' value and default occurs. The default probability is the area (129) under the curve below default point. In short, the Merton model considers the evolution of the asset value (122) given by the probability distribution (124) and calculates the default probability (129) from asset value fluctuations below default point (128). This model is a one-dimensional model that considers only fluctuations of the overall asset value (or asset value minus liabilities' value).

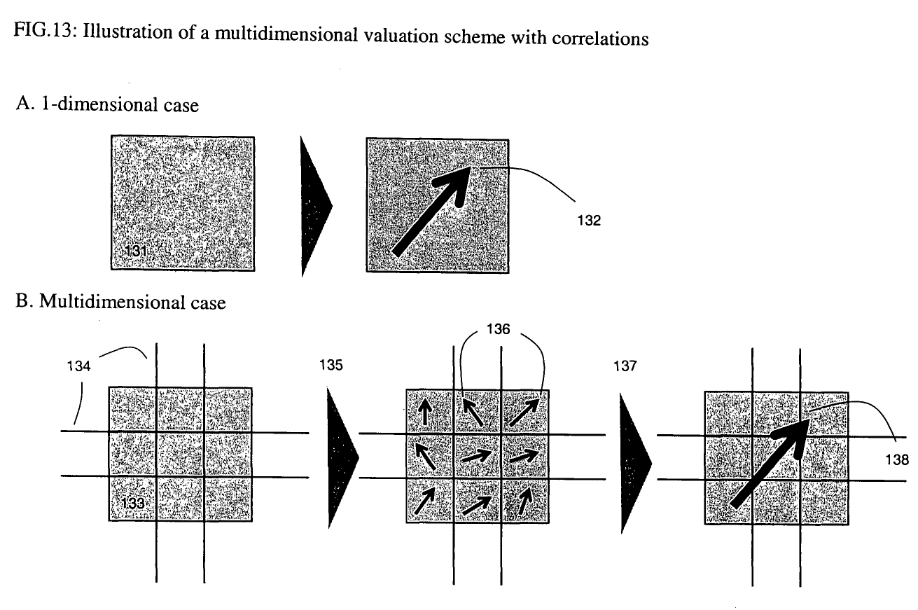

FIG. 13 compares the Merton model with the multidimensional valuation scheme with structuring and aggregation step. The vectors in FIG. 13 represent fluctuations (as described in the previous paragraph and illustrated in FIG. 10). The Merton model takes the overall asset (131) and assigns an overall risk vector (132) corresponding to the fluctuation scale (126). These variables determine the default probability. In contrast, the multidimensional valuation scheme first structures (134) the asset (133) into constituent assets. The constituents can be business, product, or functional units, or generalized assets. A risk assessment values the individual constituents (135). The individual risks depend on different factors and thus the risk vectors (136) point in different directions. The coherent aggregation (137) of the individual risks to an overall risk vector (138) for the asset requires proper consideration of the correlations between constituents.

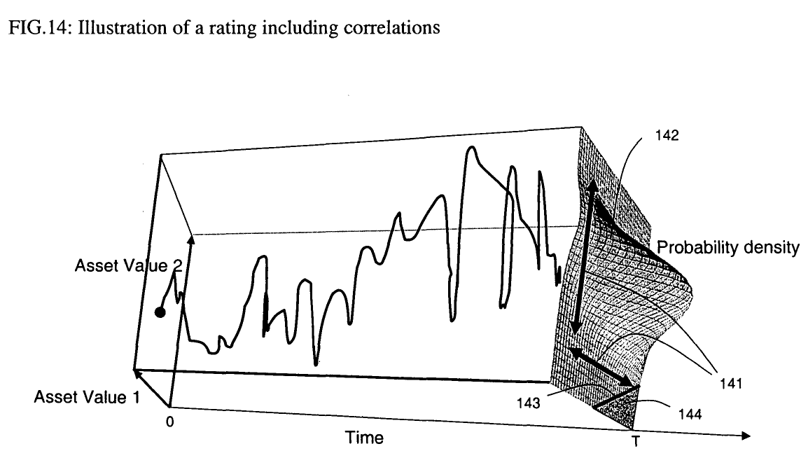

The multidimensional evolution is illustrated in FIG. 14 which extends FIG. 12 to many dimensions. Only two dimensions can be shown in FIG. 14 but generally the number of dimensions is the number of generalized assets or the number of factors, if assets are represented by factors. The probability distribution is characterized by three parameters, the two volatilities (141) of the asset value fluctuations and the correlation (142). The default probability is the volume under the area (144) that covers all aggregated fluctuations below the default line (143). The aggregated fluctuations are the aggregated risks and opportunities of the two assets.

In the special case where the valuation is a corporate rating, the first task is the assessment of risks and opportunities of the company and hierarchical structuring and hierarchical aggregation are essential methods of valuation. The main rating result in form of the company's default probability is the integration of all risks and opportunities. In addition to the already mentioned advantages, the present valuation method has further advantages when applied to corporate rating. (1.) The valuation is based on risks as well as opportunities. The default probability is not only an integral of risks but an integral of risks and opportunities. Opportunities can contribute significantly to integrated default risks because they can cancel risks statistically. Surprisingly, it seems that this fact has escaped attention so far. (2) The integration system ensures that all risks and opportunities are considered. This includes, for example, the fully canonical integration of soft facts into the rating procedure. (3) The present valuation obviates arbitrary or subjective weighing of risks in conventional ratings. The overall risk is the coherent aggregation of individual risks. Parameters are well-specified factors, factor weights, and correlations. (4) The present valuation is entirely based on future expectations. There is no bias due to historical data. (5) The valuation is based on the individual risks and opportunities of the company under consideration. There is no bias due to the properties of a benchmarks group.

Results

A feature of the described valuation method and system is that future expectations are quantified by the full probabilistic information. Probability distributions for all quantities or for all underlying factors can fully represent the current information about possible future evolutions. For example, from a probability distribution one can regain all moments of the underlying quantities and for all times into the future. Similar representations can be given in terms of stochastic processes or neural networks. This is much more than the usual single projections in business plans or the selected extreme scenarios as in best-and-worst-case-type scenarios or the one-dimensional scenarios for sensitivity analyses.

The probabilistic nature of the quantities reflects the fact that future predictions always contain uncertainties. Fully predictable events that occur with certainty are very rare. Existing valuation procedures do not treat these uncertainties and consider only mean values. They neglect future developments that deviate from the expected outcome, such as side effects or low-probability event chains that can lead to qualitatively and quantitatively significant changes in the projected future. In many cases consideration of the full spectrum of possible effects leads to significant corrections even in average values. Existing valuation procedures neglect possible deviations around the expected values and thus also neglect the induced shifts in the expected values.

At least one embodiment of the present invention can be applied to different valuations of complex systems in many fields. Different results appear as different aspects of the probability distribution for generalized values. A selection of applications is the following. (1.) As described above and illustrated in FIG. 14, in the field of corporate rating the probability that the total asset minus liabilities' value falls below zero gives the default probability of a company. In this case the asset strike value is fixed at default point and the probability to cross the strike value is the result. At least one feature includes the multidimensional valuation with aggregation. (2.) In the field of risk management the probability is fixed, say at 1%, and the asset strike value is the result. The so-called value-at-risk is the loss in value (i.e. difference of the expected value to the asset strike value) that occurs with 1% probability over a given time period. Another feature includes structuring that is according to generalized assets, and not with respect to risk types. Another feature is that all risk types are aggregated enterprise-wide and within one model, i.e. including complete correlations even between different risk types. Another feature includes uncertainties of estimates being an integral part of the valuation. (3.) In the field of controlling the company figures of balance sheet and profit-and-loss statement are represented by the probability distributions for these values. A feature includes that the probability distributions can provide consistent and complete predictions with uncertainties and correlations. (4.) In the field of quality control the probability distribution of the quality variables or of the underlying factors determines default probabilities (as in case 1) or rare fluctuations (as in case 2.). A feature is the valuation that completely and consistently can aggregate different causes for quality fluctuations.

Besides the basic figures and ratios with their term and probability structures, the results also contain derived quantities. The derived quantities incorporate certain aspects to express characteristics or to facilitate interpretation or presentation. For example, the success factors and core competence of the company are best expressed by the position or state of company or unit in terms of benchmarks or relative to its peer companies or units. This is a result of the comparisons made by the expert system (300). Most of the derived quantities are presented and stored in form of normalized values such as percentages or ratios. The visual presentation (e.g. on a computer screen or in a printed report) is by 2 and 3-dimensional surface plots and multicolor charts. The results are subject to further interpretation and analysis by the optimizing method.

The results also contain formulas or presentations (e.g. in a table or a graphics plot) that capture main results in simplified or approximate form. For example, the default probability of the rating result can be approximated by a formula that is a function of the factors and/or ratios. In the simplest case this function is just a linear sum of weighted factors or ratios. With this formula it is then possible to update the rating result (within a specifiable error range) for changed or new values of factors or ratios.

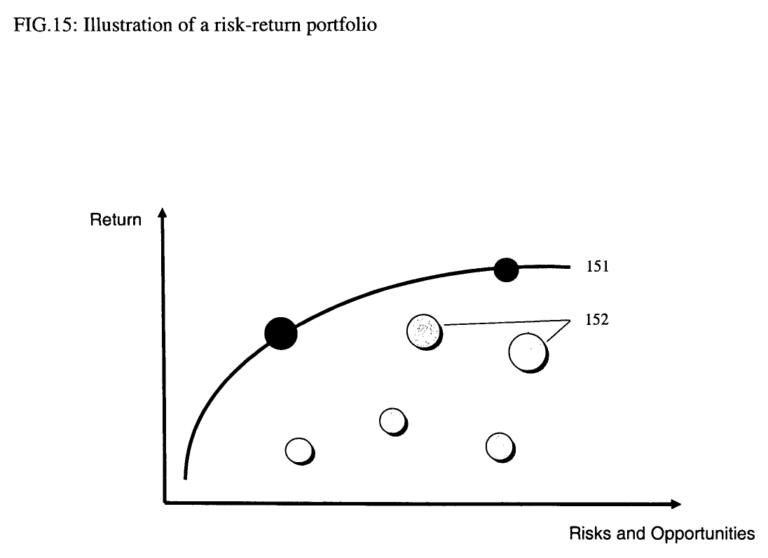

Coherent aggregation leads to diversification which is used in modern portfolio theory to determine the composition of assets in a portfolio that maximizes return and minimizes risk, resulting in an efficient frontier (151) of optimal assets (152), see FIG. 15. The present integration system uses coherent aggregation to determine efficient assets (and liabilities), processes, interfaces, functions, business units, etc. in the context of corporate valuations, where efficiency refers to the value efficiency, quality efficiency, etc.

In the case of corporate rating, the results include a representative set of figures and ratios that quantify the fundamental units in many ways and from many viewpoints. Such figures are e.g. returns and risk-adjusted returns, interest coverage ratios, operating income per-sales, different ratios for debt per capital, income or cash flow per sales, z-scores, general figures and ratios that quantify the strengths and weaknesses of the company, internal and external factors for the company, different risk and opportunity measures, such as value-at-risk, risk and opportunity concentrations, sensitivities for all considered figures and ratios and with respect to the factors (such as interest rates, exchange rates, industry and sector figures, general global and local economic, financial and political factors, weather, etc.), results of stress testing, results of simulations and scenario analyses, and many more. Many of the mentioned figures and ratios are used in different flavors and express a different degree of detail. All figures are supplied with the full probabilistic information, e.g. in terms of probability distributions, quantifying future expectations and intrinsic uncertainties.

Storage and Distribution System

The structure of the results introduces several features that allow an improved storing method. The structure of the results (1.) is independent of the hierarchy level, (2.) contains all information about the considered unit (i.e. it does not irreversibly project or reduce the information content), (3.) contains the information in integrable form, (4.) contains coherence or correlation information between the units on the same hierarchy level.

A first consequence of these features is that the original input information is recoverable from a complete set of results. Secondly, all information is provided in standardized form such that results of the same hierarchy level can be readily integrated into a consolidated result for the parent level of hierarchy.

One point in storing the results is to build and to maintain a database that contains data of the described type and with the described properties. The fluctuation and uncertainty information contained in input data and results constitute a type of data that has not yet been collected and stored by other rating or valuation methods. Especially for future benchmarking and other comparison purposes it is useful to build up such a database. The data are distributed over local and global computer networks.

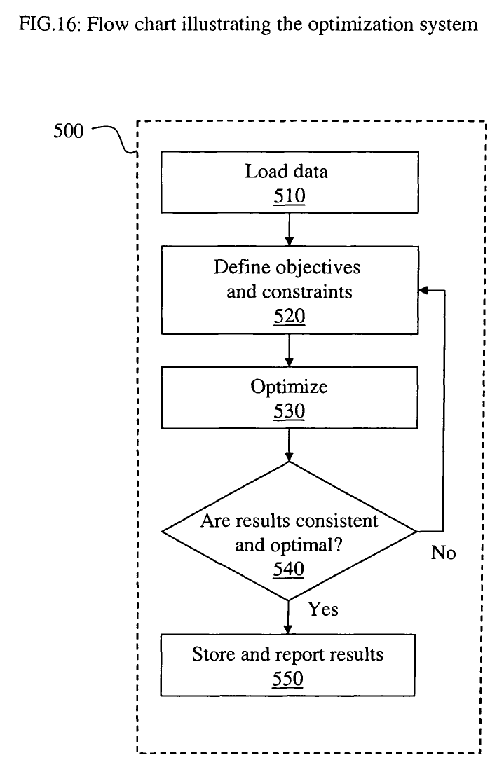

Optimization System (FIG. 16)

The optimization system (500) is an optional part of the valuation process. Its main task is to optimize strategic and functional decisions in the company or in company units.

Initially the optimization system loads (510) all the data existing of the data management system (200) and all the rules and results from the expert system (300).

In the next step the objectives and constraints have to be defined (520). The user formulates an objective function which quantifies his objectives for the future in terms of company figures, ratios, and their term structure. He also gives the constraints he wants to apply in terms of intervals, boundary values, specific values or general ranges. For example, the user wants to maximize the turnover under minimal total costs over a 3 year period at 5-10% profitability. On the user interface he selects (1.) the turnover as the objective function to be maximized, (2.) the costs as the objective function to be minimized, (3.) a progression for the degree of optimization over the 3 year period, and (4.) the 5-10% interval as a constraint for the profitability. The user can either select from a given set of objective functions and constraints or he can define his own formulae which are then interpreted by the system.

The next step is the simulation of large number of possible future scenarios (530). There are two types of simulations. The first type does a sampling of the multivariate probability distribution for the factors, i.e. by generating sets of sample values for the factors of company dynamics. This determines all possible future evolutions that satisfy the objectives under the imposed constraints. The second type does not simulate the evolution but looks for general solutions of the objective function with constraints. This type of analysis allows investigating constraints or relationships among different quantities without considering the stochastics, e.g. to determine sensitivities or to study the dynamics for fixed factors. Mixtures of both types are also possible, e.g. by fixing one factor. For all types of simulations, the simulations that satisfy the constraints are called feasible solutions and the simulation that maximizes (or minimizes) the objective function is called the optimal solution. The optimization result includes the feasible solutions including the optimal solution and including the objective function and the imposed constraints. The optimization result can constitute a basis for operational or strategic decisions.

If the optimization result is not consistent, e.g. if no feasible solution exists, or if the user wishes to repeat the simulation process for whatever reason, then a modification of the objective function or constraints is possible (540). In the automatic mode the system adjusts the constraints to find a solution if no feasible solution was found before, or, in case of degenerate optimal solutions, to reduce the set of solutions to only one optimal solution.

In a final step the optimization system stores and reports the calculated optimization results (550). The report shows (1.) the optimal and selected result, (2.) a set of close-to-optimal alternatives (the number depending on user's choice and hardware and storage capacity), and (3.) the objective function, constraints and existing modifications. The system stores the optimization results and the history of modifications in the data management system. Storing the complete optimization results guarantees that later analysis can repeat the simulations if necessary.

### Example 1

### Rating of an Automotive Supplier Producing Door Systems

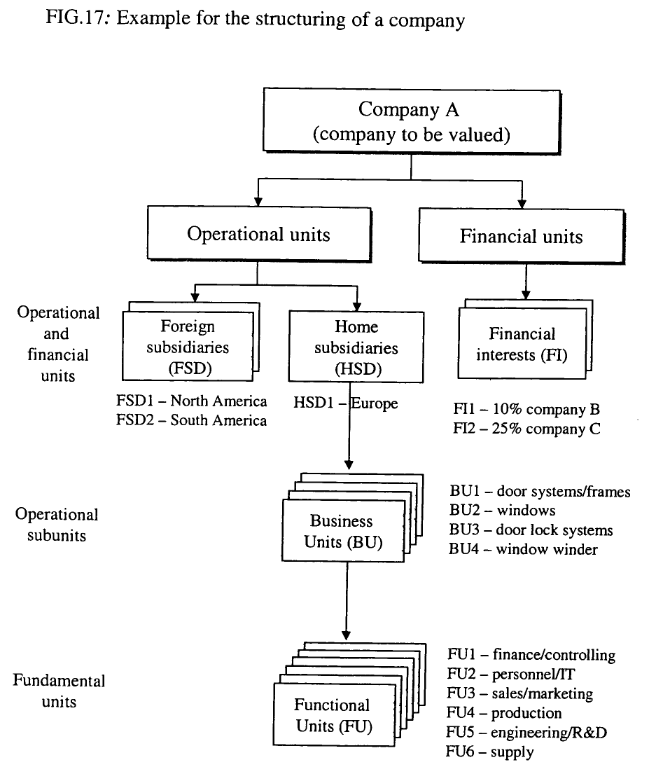

Structuring Method (FIG. 17)

Step 110:

Financial interests of company A (the company to be rated): 10% share of company B (producer of door lock systems) and 25% share of company C (producer of windows)

Step 120:

Operational units: operational units of the company A in Europe, one subsidiary in North America and one subsidiary in South America

Step 130:

Operational subunits of company A: business unit 1 (body and frame), business unit 2 (windows), business unit 3 (door lock system), business unit 4 (technical support—window winder)

Step 140:

Fundamental units: functional units of each business units—finance and controlling department, personnel and IT department, sales and marketing department, production department, engineering and R&D department, supply department

Other functions are centralized, e.g. quality department, legal department.

Data Management System

Step 210:

Externally available data of company A (input): balance sheet, profit and loss External automotive (car manufacturer) market data (input):

market volume (national and international, present and future figures),

market structure (fragmentation vs. concentration, number and characteristics of key players, production/capacity vs. demand),

market shares of car manufacturers,

market growth,

new technologies and trends,

driving forces.

External market data of suppliers and sub-suppliers (2nd tier supplier) of door frames and components (input):

market volume (national and international, present and future figures),

market structure (fragmentation vs. concentration, number and characteristics of key players, production and capacity vs. demand),

market shares of door system and components supplier,

market growth (depends on development car production),

new technologies and trends,

driving forces.

The system loads from a database external factor data, i.e. economy growth and development, exchange rates, weather, hazard event data, etc. and the corresponding volatilities and correlations.

Step 220:

The requested data are generally those next on the list determined by the optimization procedure. The system ranks data that are necessary to achieve a given precision in valuation. With the automotive module, the system ranks price, quality and technology as top input data. With the standard module, the system lists costs, cash flows, quality as input data with priority.

Based on external data (public company data and market data) the system roughly estimates which unit most likely possesses the largest losses and gains, to identify the relevant positions and functions for the analysis (in this example business unit 14)

In case of entry from step 250 (loop, see below): the system puts the request for time-to-market data for electric motor steering in business unit 4 on top of the list.

In case of entry from the integration system (step 440, see below): The final precision was not sufficient so the data management system receives a request for more input data.

Step 230:

The system requests input of internal data (past, present and expected figures) of all business units, regions, functional units, products, clients and suppliers:

Costs, sales quantity, price, turn over, profitability:

Structure (e.g. fixed and variable costs)

ABC-analysis,

Structure by clients and supplier (e.g. turn over with each client and 2nd tier-supplier)

Time series

Financial data (of all business units)

Cash flow structure (dynamic grad of debts; discounted cash flow; net cash flow)

Liquidity (1.-/2.-/3.grad)

Capital and finance structure (capital structure, net working capital, asset coverage)

Profitability structure (ROI, ROCE, turn over/profitability)

Quality data (of all processes and products)

Default rate

Service rate

The system requests input of internal factors, such as rate of absence (e.g. for productivity). The system requests volatilities, correlations and weights for those factors. The system also requests the correlations between these internal factors and external factors.

The system requests input data that quantify risks and opportunities. Among others, the system requests input of data that quantify the 3-day-to-5-day supplier default risk. This default frequency is about 1 event in 5 years with an average total loss of 2 million EUR (with 0.3 million loss of revenues) and is estimated to depend to 20% on the economic index factor and to 80% on an idiosyncratic risk factor.

The system requests input of data that quantify the risk of the investment of 100 million EUR in a just-in-time (JIT) plant in Asia. The risk depends to 60% on the exchange rate factor and to 40% on an idiosyncratic factor. The volatility of the investment is estimated to be 25% per year.

Other risks and opportunities are quantified in similar manner.

In case of entry from step 350 (loop, see below): The system requests the fixed cost data for business unit 2.

Step 240:

The system analyzes the data for consistency, coherence, and completeness. This requires a pre-valuation.

In case of first entry: The system determines that time-to-market data for electric motor steering in business unit 4 are incomplete.

Step 250:

In case of first entry: The time-to-market data for electric motor steering in business unit 4 are incomplete. The system therefore returns to step 220 to request these data.

In case of second entry: Returning with the additional input data for business unit 4, the system determines that the data are now complete, consistent and coherent.

Step 260:

The data management system stores data and reports results

Expert System

Step 310:

The expert system loads pre-defined benchmark figures (step 210)

Step 320:

The expert system compares the figures of company A (also for all business units, if detailed benchmark data exist) with those of the benchmark system; benchmarking of companies is efficient with respect to worldwide existing companies with similar structures, turn over, number of employees, subsidiaries, customers and products etc.; especially competitors appear to be the best benchmark;

Supplier company A (rated company): Net working capital ratio (liquidity coefficient; short term liabilities/current assets) 15%, profitability 5.5% supplier 2 (benchmark company): Net working capital ratio 17%, profitability 7.2% supplier 3 (benchmark company): Net working capital ratio 16%, profitability 6.9%

Step 330:

The expert system identifies strengths and weaknesses by analyzing the internal data and comparing the figures with the figures of the benchmarking-companies (for all business units): e.g. cost driver, cash-producer, cash-destroyer, life-cycle-cost, R&D-cost in relation to turn over, purchase structure (make or buy), cost development in relation to profit and turn over development, profit and sales per region, sales representative and customer. (This step is repeated for all business units and fundamental units).

Results for strength and weaknesses relative to benchmarks:

High profitability

small default rate (due to solid engineering and experience of the R&D department/employees)

short number of clients

Step 340:

The expert system identifies individual risks and opportunities by analyzing the internal and external data and by comparing the figures with the figures of the benchmarking-companies (for all business units and fundamental units)

The expert system identifies project risks and opportunities not already captured in step 230:

High cost position (high share of fixed costs) leads to smaller profitability

In case of first entry: The system determines that additional data are necessary for quantification. The fixed cost data of business unit 2 are required.

Step 350:

In case of first entry: The fixed cost data of business unit 2 are required. The system returns to step 230 to request these data.

In case of second entry: The system has no further request for data.

Step 360:

The expert system stores and reports results

Integration System

Step 410:

The inputs contain also estimates and expectations. This stochastic or probabilistic information was captured through volatilities, correlations, factors and factor weights. The complete probabilistic information is contained in the factors; they describe the dynamics of all fluctuating quantities.

Step 420:

In this example the factors are modeled with multivariate Gaussian distribution functions.

Step 430:

A Monte-Carlo sampling of those factors amounts to different simulated evolutions of the factors and consequently of all related fluctuating quantities. A set of many simulations produces a spectrum of different outcomes. This spectrum is the probability distribution function. Since the fluctuations of the value of the assets (minus liabilities) of the company is given in terms of the factors, the simulation of factors produces probability functions for the value of the assets (minus liabilities). If the value of the assets (minus liabilities) falls below zero, the company will default. The default probability is therefore the probability that the value of the assets (minus liabilities) strikes zero within the considered time span of 1 year. As a result, the system calculates from the aggregated risks and opportunities a default probability of 0.95%, corresponding to a rating class BB (S&P class).

Step 440:

In case of first entry: The precision of the calculated liquidity figures does not fulfill the preset precision requirement. The system returns to step 220 to request more input data for a more detailed analysis.

In case of second entry: Returning with the additional input data, the precision of the calculated figures fulfills requirements.

Step 450:

The integration system stores and reports results

### Example 2

### Quality Valuation of a Production Line “Paint Shop” in the Automotive Industry

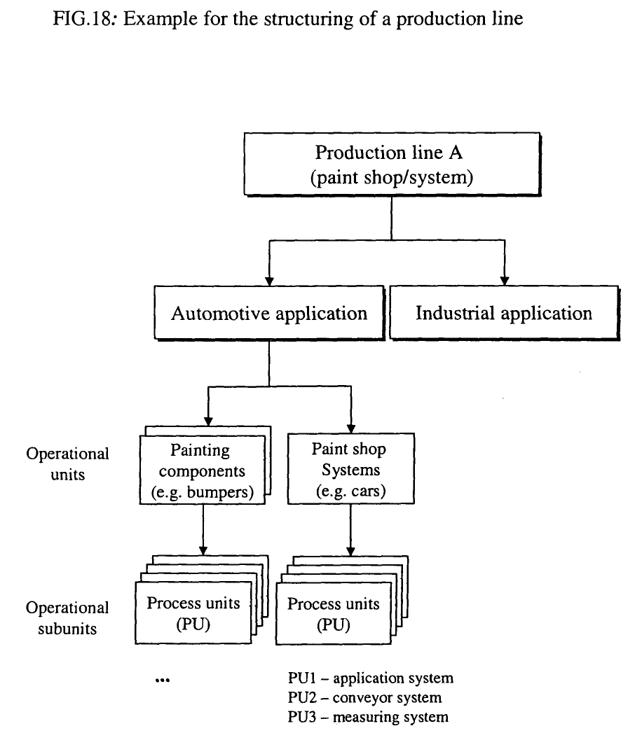

Structuring Method (FIG. 18)

Step 110:

Industrial application e.g.: manufacturer of furniture or big components (synthetic parts for electronic industry)

Step 120:

Operational units of the automotive application: painting components (e.g. bumpers) and paint shops (e.g. cars);

Step 130:

Operational subunits of the paint shop: process unit 1—application system, process unit 2—conveyor system; process unit 3—measuring system;

Step 140:

The fundamental units of the paint shop are the components of the process units (single parts); these components and the industrial application will not be considered in this example.

Data Management System

Step 210:

Externally available data of the painting production line (rated paint shop and their process units): technical data sheets, product descriptions and specifications;

External data of other suppliers and sub-suppliers (2nd tier supplier) of paint shops, application systems, conveyor systems and measuring systems:

standard figures for quality (national and international, present and future figures),

standard ranges for measurement (ranges for bad, medium and good quality),

market criteria for quality,

new technologies and trends (offer supplier side)

driving forces.

External automotive and customer market data:

quality limits of customers,

average quality demand,

new technologies and trends (demand customer side),

driving forces.

The system loads from a database external factors, i.e. economic development and growth, weather, costs, hazard event data, etc., and the corresponding volatilities and correlations.

Step 220:

The requested data are generally those next on the list determined by the optimization procedure. The system ranks data that are necessary to achieve a given precision in valuation: life-cycle-position, technical performance, quality data.

Based on public external data the system roughly estimates which process unit is expected to have the largest impact on the result of the quality valuation.

In case of entry from step 250 (loop, see below): the system puts the request for additional historical default data of process unit 2 and additional factor weight data for process unit 3 on top of the list.

In case of entry from the integration system (step 440—see below): the system requests more input data.

Step 230:

The system requests input of internal data (past, present and expected figures) of all process units 1-3:

Life-cycle-position

Age of process units and components,

State of the art technology,

Costs per unit (cost of coated car),

Process costs,

Innovation rate,

Depreciations;

Technical performance

Automation grade

Capacities,

Processing time,

Flexibility grad (e.g. time for changing the color, the car type),

Measured wet paint film thickness;

Others

Number of suppliers,

Experience of suppliers,

Experience of user;

Quality data

Default rate,

Service rate,

Scratch resistance,

Quality of the components;

The system requests input of data that quantify the fluctuations in quality. Those data can be data from statistical analysis of historical quality fluctuations or estimates that quantify expectations for future events. Quality risks come from rare and sudden events and from frequent or permanent fluctuations. The rare event group contains e.g. malfunctions of single paint jets causing infrequent and sudden degrades of quality. The event frequency is about 7 events per year, and the associated quality degradation about 5%. The factor weights are to 5% factor temperature, 15% paint consistency and 80% idiosyncratic factor. The frequent quality fluctuation group contains e.g. air impurities. This quantity is monitored and was already captured as a factor. Air impurities also exhibit strong fluctuations due to events, e.g. as a consequence of air filter failure. This and other quality risks are quantified. This is done for all units.

In case of entry from step 350 (loop, see below): The system requests additional detail and data for the color exchange process.

Step 240:

The data management system analysis data (for all process units): e.g. quality driver, quality destroyer, quality limits (external and internal standard), life-cycle-position, etc. The system checks if the data are complete, consistent and coherent.

In case of first entry: The system determines that fixed cost structure of process unit 1 is incomplete.

The system aggregates all data to get a pre-valuation.

Step 250:

In case of first entry: Additional historical default data for process unit 2 and factor weight data for process unit 3 are required. The system therefore returns to step 220 to requests these data.

In case of second entry: Returning with the additional input data for process unit 2 and 3, the system determines that the data are now complete, consistent and coherent.

Step 260:

The data management system stores data and reports results

Expert System

Step 310:

The expert system loads pre-defined benchmark figures (step 210)

Step 320:

The expert system compares the figures of the production line “paint shop” (also for all process units, if detailed benchmark data exist) with those of the benchmark system; benchmarking of production lines is efficient with respect to worldwide existing production lines with similar functions, applications, technical data, price, customers and components etc.; especially competitors appear to be the best benchmark;

Production line A (rated production line): Paint shop A: default rate is 0.85% Production line B (benchmark production line): Paint shop B: default rate is 0.70% Production line C (benchmark production line): Paint shop C: default rate is 0.73%;

Step 330:

The expert system identifies strengths and weaknesses by analyzing the internal data and comparing the figures with the figures of the benchmark companies (this step repeats for all process units);

Results for the strengths and weaknesses relative to benchmarks:

Short number of suppliers

Small cost per unit

Low process flexibility (long time exchanging colors)

High default rate

Step 340:

The expert system identifies individual risks and opportunities by analyzing the internal and external data and comparing the figures with the figures of the benchmark production lines (for all process units)

The system plots probability distributions for all key figures. The following examples are derived from those probability distributions:

Identified quality risks and opportunities not already captured in steps 230: Long color exchange time leads to increased coating.

Step 350:

In case of first entry: The system determines that the color exchange process needs a more detailed quantification. The system returns to step 230 to request more data.

In case of second entry: The system has no further request for data.

Step 360:

The systems stores and reports results

Integration System

Step 410:

The inputs contain estimates and expectations. This stochastic or probabilistic information was captured through volatilities, correlations, factors and factor weights. The complete probabilistic information is contained in the factors; they describe the dynamics of the figures.

Step 420:

In this example the factors are modeled with multivariate Gaussian distribution functions. For performance reasons the system orthogonalizes and normalizes the factors, i.e. the original factors are transformed into an equivalent set of new orthogonal factors with unit volatility.

Step 430:

A Monte-Carlo sampling of those factors amounts to different simulated evolutions of the quality and of related quantities. A set of many simulations produces a spectrum of different outcomes. This spectrum is the probability distribution function. Since quality and related quantities are given in terms of the factors, the simulation of factors produces probability distributions for quality and related quantities. The simulation aggregates the quality fluctuations, i.e. it integrates all effects that influence total quality risk, including all interrelations between causes and all joint events that may enhance or cancel each other.

The probability that the overall quality of the car paint decreases by 5% within the next 2 hours is found to be 0.3%. Some other results are the probability that the overall quality of the car paint decreases beyond the minimum specification within the next day, the risk concentrations, i.e. quality risk and opportunity sensitivities with respect to the factors, the quality risk and opportunity map etc.

Step 440:

In case of first entry: The precision of the calculated quality figures does not fulfill the preset requirement. The system returns to step 220 to request more input data for a more detailed analysis.

In case of second entry: Returning with the additional input data, the precision of the calculated figures fulfill the requirements.

Step 450:

The integration system stores and reports results

The invention being thus described, it will be obvious that the same may be varied in many ways. For example, any and all of the methods of the various embodiments of the present application may be embodied on a computer readable medium. Such a computer-readable medium includes but is not limited to a floppy disc, CD, optical disc, etc. Such a computer-readable medium may include, for example, computer executable instructions configured to cause a computer device to perform any and all of the methods of the various embodiments of the present application. The computer readable medium may include code portions embodied thereon that, when read by a processor or computer device (such as that of a network server, or any other type of computer device), cause the processor to perform one or more steps of any and all of the methods of the various embodiments of the present application.

Accordingly, any and all variations of the various embodiments of the present invention are not to be regarded as a departure from the spirit and scope of the invention, and all such modifications as would be obvious to one skilled in the art are intended to be included within the scope of the following claims.

What is claimed is:

1. A system of producing a rating result for a corporation, comprising:
means for partitioning the corporation into non-overlapping units;
means for specifying risks, opportunities, and factors for each of the non-overlapping units;
means for quantifying expectations, uncertainties, and correlations associated with the specified risks, opportunities, and factors;
means for entering into a data management system including data relating to the quantifications of associated expectations, uncertainties, and correlations;
means for consolidating the specified risks and opportunities, including the effects of the uncertainties and correlations, to thereby produce a rating result.

2. The system as claimed in claim 1, wherein the system automatically at least one of collects and requests data upon an achieved precision of the produced rating result not being sufficient.

3. The system as claimed in claim 1, wherein the means for specifying is also for identifying weaknesses and strengths of said non-overlapping units.

4. The system as claimed in claim 2, further comprising:
means for analyzing collected data, in relation to reference data, to measure features of the collected data.

5. The system as claimed in claim 2, further comprising:
means for at least one of analyzing and integrating the collected data, in relation to known factors, to represent effects of at least one of correlations and interdependencies among the selected quantities.

6. The system as claimed in claim 5, further comprising:
means for consolidating said selected quantities, including effects of the uncertainties and correlations.

7. The system as claimed in claim 1, further comprising:
means for reporting an estimate, in real-time, of an obtainable rating with a current data set of a corporation.

8. A system of valuation comprising:
means for selecting a partition of a valuation object into non-overlapping units;
means for specifying quantities that represent specific aspects of the non-overlapping units;
means for quantifying the expectations, uncertainties, and correlations associated with the specified quantities;
means for entering into a data management system including data relating to the specified quantities and the quantifications of associated expectations, uncertainties, and correlations;
means for consolidating the quantities, including the effects of the uncertainties and correlations, to thereby produce a valuation result.

9. The system as claimed in claim 8, wherein the system automatically at least one of collects and requests data upon an achieved precision of the produced valuation result not being sufficient.

10. The system as claimed in claim 8, wherein the means for specifying is also for identifying weaknesses and strengths of said non-overlapping units.

11. The system as claimed in claim 9, further comprising:
means for analyzing collected data, in relation to reference data, to measure features of the collected data.

12. The system as claimed in claim 9, further comprising:
means for at least one of analyzing and integrating the collected data, in relation to known factors, to represent effects of at least one of correlations and interdependencies among the selected quantities.

13. The system as claimed in claim 12, further comprising:
means for consolidating said selected quantities, including effects of the uncertainties and correlations.

14. The system as claimed in claim 8, further comprising:
means for reporting an estimate, in real-time, of an obtainable valuation with a current data set of a corporation.

15. A method of producing a rating result for a corporation, comprising:
selecting a partition of the corporation into non-overlapping units;
entering into a data management system relating to risks, opportunities, and factors for said non-overlapping units, including data relating to quantifications of expectations, uncertainties, and correlations associated with the risks, opportunities, and factors;
consolidating the risks and opportunities, including the effects of the uncertainties and correlations, to thereby produce a rating result.

16. A method of valuation comprising the steps of:
selecting a partition of a valuation object into non-overlapping units;
entering into a data management system including data relating to quantities representing specific aspects of the non-overlapping units, including data relating to quantifications of expectations, uncertainties, and correlations of the quantities;
consolidating the quantities, including the effects of the uncertainties and correlations, to thereby produce a valuation result.

17. The method of claim 15 wherein the selecting includes constraining selection to partitions along one level in an organizational hierarchy of the corporation.

18. The method of claim 16 wherein the selecting includes constraining selection to partitions along one level in an organizational hierarchy of the valuation object.

19. The method of claim 15, wherein the expectations, uncertainties, and correlations are quantified in form of probability distributions.

20. The method of claim 16, wherein the expectations, uncertainties, and correlations are quantified in form of probability distributions.

21. The method of claim 15, further comprising interactively and iteratively collecting data relating to the corporation that checks data for completeness and consistency.

22. The method of claim 16, further comprising interactively and iteratively collecting data relating to the valuation object that checks data for completeness and consistency.

23. The method of claim 19, wherein the consolidating includes integrating an equivalent of multidimensional probability distributions.

24. The method of claim 20, wherein the consolidating includes integrating an equivalent of multidimensional probability distributions.

25. The method of claim 15, wherein a precision of the rating result is also produced.

26. The method of claim 16, wherein a precision of the valuation result is also produced.

27. The method of claim 15, wherein information regarding dependencies of the rating result is also produced.

28. The method of claim 16, wherein information regarding dependencies of the valuation result is also produced.

29. The method of claim 15, wherein a formula is also produced, including functions of at least one of factors and ratios that approximate the rating result with calculable precision.

30. The method of claim 16, wherein a formula is also produced, including functions of at least one of factors and ratios that approximate the rating result with calculable precision.

31. The method of claim 15, further comprising:
analyzing the non-over-lapping units with an expert system.

32. The method of claim 16, further comprising:
analyzing the non-over-lapping units with an expert system.

33. The method of claim 15, further comprising:
storing the rating result in a database.

34. The method of claim 15, further comprising:
storing the valuation result in a database.

35. The method of claim 15, further comprising:
distributing the rating result by at least one of a local and global computer network.

36. The method of claim 16, further comprising:
distributing the valuation result by at least one of a local and global computer network.

37. The method of claim 15, further comprising:
optimizing the corporation based on the rating result.

38. The method of claim 15, further comprising:
optimizing the valuation object based on the valuation result.

39. The method of claim 31, wherein the expert system compares the non-overlapping units with benchmark units.

40. The method of claim 32, wherein the expert system compares the non-overlapping units with benchmark units.

41. The method of claim 31, wherein the expert system identifies at least one of the weaknesses, strengths, risks, opportunities, and factors of the non-overlapping units.

42. The method of claim 32, wherein the expert system identifies at least one of the weaknesses, strengths, risks, opportunities, and factors of the non-overlapping units.

43. The method of claim 31, wherein the expert system derives suggestions to optimize at least one of operation, performance, and competitiveness of the non-overlapping units.

44. The method of claim 32, wherein the expert system derives suggestions to optimize at least one of operation, performance, and competitiveness of the non-overlapping units.

45. The method of claim 15, wherein more than 20 individual risks of the corporation, including any constituents, are consolidated with explicit consideration and consolidation of uncertainties and correlations.

46. The method of claim 16, wherein more than 20 individual risks of the valuation object are consolidated with explicit consideration and consolidation of uncertainties and correlations.

47. The method of claim 15, wherein more than 10 individual risks and 5 opportunities of the corporation, including any constituents, are consolidated with explicit consideration and consolidation of uncertainties and correlations.

48. The method of claim 16, wherein more than 10 individual risks and 5 opportunities of the valuation object are consolidated with explicit consideration and consolidation of uncertainties and correlations.

49. The method of claim 15, wherein more than 10 different quantities representing specific aspects of corporation, including any constituents, are consolidated with explicit consideration and consolidation of uncertainties and correlations.

50. The method of claim 16, wherein more than 10 different quantities representing specific aspects of the valuation object are consolidated with explicit consideration and consolidation of uncertainties and correlations.

51. A computer-readable medium comprising computer executable instructions configured to cause a computer device to perform the method of claim 15.

52. A computer-readable medium comprising computer executable instructions configured to cause a computer device to perform the method of claim 16.

53. A system of producing a rating for a corporation, comprising:
means for specifying at least risks and opportunities for non-overlapping units of the corporation;
means for quantifying at least uncertainties and correlations associated with the risks and opportunities;
means for consolidating the risks and opportunities, including the effects of the uncertainties and correlations, to produce the rating.

54. The system of claim 53, wherein the means for consolidating includes a data management system including data relating to the specified quantifications of uncertainties and correlations.

55. A system of valuation comprising:
means for specifying quantities representing specific aspects of non-overlapping units of a valuation object;
means for quantifying at least uncertainties, and correlations associated with the specified quantities;
means for consolidating the quantities, including the effects of the uncertainties and correlations, to produce a valuation.

56. The system of claim 55, wherein the means for consolidating includes a data management system including data relating to the specified quantities and the quantifications of associated uncertainties and correlations.
